(19) United States
(12) Patent Application Publication
(10) Pub. No.: US 2026/0261890 A1
(43) Pub. Date: Sep. 3, 2026

(54) LINK MONITORING ACROSS MULTIPLE-CELLS FOR MULTI-CARRIER OPERATION

(71) Applicant: QUALCOMM Incorporated, San Diego, CA (US)

(72) Inventors: Kianoush HOSSEINI, San Diego, CA (US); Alberto RICO ALVARINO, San Diego, CA (US)

(21) Appl. No.: 19/553,096

(22) Filed: Feb. 27, 2026

Related U.S. Application Data
(60) Provisional application No. 63/766,067, filed on Mar. 3, 2025.

(51) Int. Cl. H04W 24/08; H04L 5/00; H04W 36/00; H04W 36/30

(52) U.S. Cl. CPC H04W 24/08; H04L 5/0051; H04W 36/0061; H04W 36/30

(57) ABSTRACT

Methods, systems, and devices for wireless communications are described. A user equipment (UE) may receive a control message indicating a multi-cell radio link monitoring (RLM) configuration for multiple cells including a primary cell and at least one secondary cell. The multi-cell RLM configuration may indicate multiple reference signal sets for monitoring the multiple cells. The UE may monitor the multiple reference signal sets to obtain a first channel quality metric associated with the primary cell and one or more second channel quality metrics associated with the at least one secondary cell in accordance with the multi-cell RLM configuration. The UE may transmit cell switch information based on the first channel quality metric satisfying a cell switch criterion and the one or more second channel quality metrics.

### CROSS REFERENCE

The present Application for Patent claims the benefit of U.S. Provisional Patent Application No. 63/766,067 by HOSSEINI et al., entitled “LINK MONITORING ACROSS MULTIPLE-CELLS FOR MULTI-CARRIER OPERATION,” filed Mar. 3, 2025, assigned to the assignee hereof, and which is expressly incorporated by reference in its entirety herein.

### FIELD OF TECHNOLOGY

The following relates to wireless communications, including link monitoring across multiple cells for multi-carrier operation.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The systems, methods, and devices of this disclosure each have several innovative aspects, no single one of which is solely responsible for the desirable attributes disclosed herein.

In some wireless communications systems, a network entity may configure a user equipment (UE) in carrier aggregation with a first cell (e.g., a primary cell) and one or more second cells (e.g., secondary cells). The first cell may be configured to perform one or more physical layer functionalities, and the one or more second cells may be configured to transmit downlink data, or receive uplink data, or both, with the UE. The UE may perform radio link monitoring (RLM) on the primary cell. For example, the first cell may transmit one or more reference signals to the UE, and the UE may measure a channel quality metric using the one or more reference signals. In some cases, the first cell may communicate with the UE via an unreliable communication connection. If the channel quality metric satisfies a threshold (e.g., indicates unreliable channel conditions on the primary cell), the UE may perform a handover procedure or transmit an indication of radio link failure (RLF). The UE may perform the handover procedure or transmit the indication of RLF associated with the primary cell even if a second cell communicates with the UE via a reliable communication connection. In the case of an RLF, the UE may reestablish a connection with a different cell as a primary cell. In the case of a handover procedure, the UE may establish a connection with a different cell as a primary cell after the handover procedure. The handover procedure or RLF procedure may decrease communication efficiency and increase latency.

According to techniques described herein, the UE may support RLM across multiple cells including the first cell and the one or more second cells. For example, the network entity may configure the UE with a muti-cell RLM configuration for multiple cells. The UE may perform RLM on the multiple cells. For example, the first cell and the one or more second cells may transmit reference signals to the UE. The UE may obtain channel quality metrics for multiple cells (e.g., the first cell and the one or more second cells). If a channel quality metric associated with the first cell satisfies channel switch criteria (e.g., indicates unreliable channel conditions on the first cell), the UE may transmit cell switch information. The cell switch information may include information (e.g., related to the RLM or RLF) indicating a cell switch. In some examples, the cell switch information may indicate that one or more physical layer functionalities performed by the first cell are being switched to a second cell. In some examples, the cell switch information may indicate one or more second cells with channel quality metrics that satisfy a threshold (e.g., indicating reliable channel conditions on the secondary cells) that the UE requests the one or more physical layer functionalities be switched to. The RLM across multiple cells may increase communication efficiency and decrease latency associated with handover procedures and RLF procedures.

A method by a UE is described. The method may include receiving a control message indicating a multi-cell RLM configuration for a set of multiple cells including a primary cell and at least one secondary cell, the multi-cell RLM configuration indicating a set of multiple reference signal sets for monitoring the set of multiple cells and monitoring the set of multiple reference signal sets to obtain a first channel quality metric associated with the primary cell and one or more second channel quality metrics associated with the at least one secondary cell in accordance with the multi-cell RLM configuration.

A UE is described. The UE may include one or more memories storing processor executable code, and one or more processors coupled with the one or more memories. The one or more processors may individually or collectively be operable to execute the code to cause the UE to receive a control message indicating a multi-cell RLM configuration for a set of multiple cells including a primary cell and at least one secondary cell, the multi-cell RLM configuration indicating a set of multiple reference signal sets for monitoring the set of multiple cells and monitor the set of multiple reference signal sets to obtain a first channel quality metric associated with the primary cell and one or more second channel quality metrics associated with the at least one secondary cell in accordance with the multi-cell RLM configuration.

Another UE is described. The UE may include means for receiving a control message indicating a multi-cell RLM configuration for a set of multiple cells including a primary cell and at least one secondary cell, the multi-cell RLM configuration indicating a set of multiple reference signal sets for monitoring the set of multiple cells and means for monitoring the set of multiple reference signal sets to obtain a first channel quality metric associated with the primary cell and one or more second channel quality metrics associated with the at least one secondary cell in accordance with the multi-cell RLM configuration.

A non-transitory computer-readable medium storing code is described. The code may include instructions executable by one or more processors to receive a control message indicating a multi-cell RLM configuration for a set of multiple cells including a primary cell and at least one secondary cell, the multi-cell RLM configuration indicating a set of multiple reference signal sets for monitoring the set of multiple cells and monitor the set of multiple reference signal sets to obtain a first channel quality metric associated with the primary cell and one or more second channel quality metrics associated with the at least one secondary cell in accordance with the multi-cell RLM configuration.

Some examples of the method, UEs, and non-transitory computer-readable medium described herein may further include operations, features, means, or instructions for transmitting cell switch information based on the first channel quality metric satisfying a cell switch criterion and the one or more second channel quality metrics.

In some examples of the method, UEs, and non-transitory computer-readable medium described herein, monitoring the set of multiple reference signal sets may include operations, features, means, or instructions for monitoring a first reference signal set of the set of multiple reference signal sets to obtain the first channel quality metric associated with the primary cell and monitoring, based on the first channel quality metric satisfying the cell switch criterion, a second reference signal set of the set of multiple reference signal sets to obtain the one or more second channel quality metrics.

Some examples of the method, UEs, and non-transitory computer-readable medium described herein may further include operations, features, means, or instructions for receiving an indication of a secondary cell of the at least one secondary cell, where the second reference signal set may be monitored based on the indication of the secondary cell.

Some examples of the method, UEs, and non-transitory computer-readable medium described herein may further include operations, features, means, or instructions for detecting a quantity of out-of-sync (OoS) indications that occur prior to a monitoring window and detecting a quantity of in-sync (IS) indications that occur during the monitoring window, where the first channel quality metric satisfies the cell switch criterion based on the quantity of OoS indications satisfying a first threshold and the quantity of IS indications satisfying a second threshold.

Some examples of the method, UEs, and non-transitory computer-readable medium described herein may further include operations, features, means, or instructions for switching one or more physical layer functionalities from the primary cell to a secondary cell of the at least one secondary cell based on the first channel quality metric satisfying the cell switch criterion and communicating, via the secondary cell, one or more messages associated with the one or more physical layer functionalities.

Some examples of the method, UEs, and non-transitory computer-readable medium described herein may further include operations, features, means, or instructions for refraining, after switching the one or more physical layer functionalities from the primary cell to the secondary cell, from monitoring a first reference signal set of the set of multiple reference signal sets based on the first channel quality metric satisfying the cell switch criterion, where the first reference signal set may be associated with the primary cell.

Some examples of the method, UEs, and non-transitory computer-readable medium described herein may further include operations, features, means, or instructions for monitoring, after switching the one or more physical layer functionalities from the primary cell to the secondary cell, a first reference signal set of the set of multiple reference signal sets, where the first reference signal set may be associated with the primary cell.

Some examples of the method, UEs, and non-transitory computer-readable medium described herein may further include operations, features, means, or instructions for transmitting an indication of RLF based on the first channel quality metric satisfying the cell switch criterion and the one or more second channel quality metrics satisfying a RLF threshold.

In some examples of the method, UEs, and non-transitory computer-readable medium described herein, transmitting the cell switch information may include operations, features, means, or instructions for transmitting, via uplink resources indicated by the multi-cell RLM configuration, an indication that one or more physical layer functionalities may have been switched from the primary cell to a secondary cell of the at least one secondary cell.

In some examples of the method, UEs, and non-transitory computer-readable medium described herein, the uplink resources may be associated with the secondary cell.

In some examples of the method, UEs, and non-transitory computer-readable medium described herein, transmitting the cell switch information may include operations, features, means, or instructions for transmitting an indication of a beam associated with the secondary cell based on a beam quality metric associated with the beam.

Some examples of the method, UEs, and non-transitory computer-readable medium described herein may further include operations, features, means, or instructions for receiving, based on the cell switch information, a second control message indicating a communication configuration for a secondary cell of the at least one secondary cell and communicating, via the secondary cell, one or more messages in accordance with the communication configuration.

In some examples of the method, UEs, and non-transitory computer-readable medium described herein, transmitting the cell switch information may include operations, features, means, or instructions for transmitting an indication of one or more secondary cells of the at least one secondary cell, where each second channel quality metric of the one or more second channel quality metrics associated with the one or more secondary cells satisfies a threshold.

Some examples of the method, UEs, and non-transitory computer-readable medium described herein may further include operations, features, means, or instructions for receiving an indication of a secondary cell of the one or more secondary cells based on the indication of the one or more secondary cells and communicating, via the secondary cell, one or more messages based on the indication of the secondary cell.

A method for wireless communications by a network entity is described. The method may include transmitting a control message indicating a multi-cell radio link monitoring configuration for a set of multiple cells including a primary cell and at least one secondary cell, the multi-cell radio link monitoring configuration indicating a set of multiple reference signal sets for monitoring the set of multiple cells and transmitting a first set of radio link monitoring reference signals via a first reference signal set of the set of multiple reference signal sets.

A network entity for wireless communications is described. The network entity may include one or more memories storing processor executable code, and one or more processors coupled with the one or more memories. The one or more processors may individually or collectively be operable to execute the code to cause the network entity to transmit a control message indicating a multi-cell radio link monitoring configuration for a set of multiple cells including a primary cell and at least one secondary cell, the multi-cell radio link monitoring configuration indicating a set of multiple reference signal sets for monitoring the set of multiple cells and transmit a first set of radio link monitoring reference signals via a first reference signal set of the set of multiple reference signal sets.

Another network entity for wireless communications is described. The network entity may include means for transmitting a control message indicating a multi-cell radio link monitoring configuration for a set of multiple cells including a primary cell and at least one secondary cell, the multi-cell radio link monitoring configuration indicating a set of multiple reference signal sets for monitoring the set of multiple cells and means for transmitting a first set of radio link monitoring reference signals via a first reference signal set of the set of multiple reference signal sets.

A non-transitory computer-readable medium storing code for wireless communications is described. The code may include instructions executable by one or more processors to transmit a control message indicating a multi-cell radio link monitoring configuration for a set of multiple cells including a primary cell and at least one secondary cell, the multi-cell radio link monitoring configuration indicating a set of multiple reference signal sets for monitoring the set of multiple cells and transmit a first set of radio link monitoring reference signals via a first reference signal set of the set of multiple reference signal sets.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a wireless communications system that supports link monitoring across multiple-cells for multi-carrier operation in accordance with one or more aspects of the present disclosure.

FIG. 2 shows an example of a wireless communications system that supports link monitoring across multiple-cells for multi-carrier operation in accordance with one or more aspects of the present disclosure.

FIG. 3 shows an example of a resource timeline that supports link monitoring across multiple-cells for multi-carrier operation in accordance with one or more aspects of the present disclosure.

FIG. 4 shows an example of a process flow that supports link monitoring across multiple-cells for multi-carrier operation in accordance with one or more aspects of the present disclosure.

FIGS. 5 and 6 show block diagrams of devices that support link monitoring across multiple-cells for multi-carrier operation in accordance with one or more aspects of the present disclosure.

FIG. 7 shows a block diagram of a communications manager that supports link monitoring across multiple-cells for multi-carrier operation in accordance with one or more aspects of the present disclosure.

FIG. 8 shows a diagram of a system including a device that supports link monitoring across multiple-cells for multi-carrier operation in accordance with one or more aspects of the present disclosure.

FIGS. 9 and 10 show block diagrams of devices that support link monitoring across multiple-cells for multi-carrier operation in accordance with one or more aspects of the present disclosure.

FIG. 11 shows a block diagram of a processing system that supports link monitoring across multiple-cells for multi-carrier operation in accordance with one or more aspects of the present disclosure.

FIG. 12 shows a diagram of a system including a device that supports link monitoring across multiple-cells for multi-carrier operation in accordance with one or more aspects of the present disclosure.

FIGS. 13 through 16 show flowcharts illustrating methods that support link monitoring across multiple-cells for multi-carrier operation in accordance with one or more aspects of the present disclosure.

### DETAILED DESCRIPTION

In some wireless communications systems, a network entity may configure a user equipment (UE) in carrier aggregation with a first cell (e.g., a primary cell) and one or more second cells (e.g., secondary cells). The first cell may be configured to perform one or more physical layer functionalities, and the one or more second cells may be configured to transmit downlink data, or receive uplink data, or both, with the UE. The UE may perform radio link monitoring (RLM) on the primary cell. For example, the first cell may transmit one or more reference signals to the UE, and the UE may measure a channel quality metric using the one or more reference signals. In some cases, the first cell may communicate with the UE via an unreliable communication connection. If the channel quality metric satisfies a threshold (e.g., indicates unreliable channel conditions on the primary cell), the UE may perform a handover procedure or transmit an indication of radio link failure (RLF). The UE may perform the handover procedure or transmit the indication of RLF associated with the primary cell even if a second cell communicates with the UE via a reliable communication connection. In the case of an RLF, the UE may reestablish a connection with a different cell as a primary cell. In the case of a handover procedure, the UE may establish a connection with a different cell as a primary cell after the handover procedure. The handover procedure or RLF procedure may decrease communication efficiency and increase latency.

According to techniques described herein, the UE may support RLM across multiple cells including the first cell and the one or more second cells. For example, the network entity may configure the UE with a muti-cell RLM configuration for multiple cells. The UE may perform RLM on the multiple cells. For example, the first cell and the one or more second cells may transmit reference signals to the UE. The UE may obtain channel quality metrics for multiple cells (e.g., the first cell and the one or more second cells). If a channel quality metric associated with the first cell satisfies channel switch criteria (e.g., indicates unreliable channel conditions on the first cell), the UE may transmit cell switch information. The cell switch information may include information (e.g., related to the RLM or RLF) indicating a cell switch. In some examples, the cell switch information may indicate that one or more physical layer functionalities performed by the first cell are being switched to a second cell. In some examples, the cell switch information may indicate one or more second cells with channel quality metrics that satisfy a threshold (e.g., indicating reliable channel conditions on the secondary cells) that the UE requests the one or more physical layer functionalities be switched to. The RLM across multiple cells may increase communication efficiency and decrease latency associated with handover procedures and RLF procedures.

Aspects of the disclosure are initially described in the context of wireless communications systems. Additional aspects of the disclosure are described in the context of a resource timeline and a process flow. Aspects of the disclosure are further illustrated by and described with reference to apparatus diagrams, system diagrams, and flowcharts that relate to link monitoring across multiple-cells for multi-carrier operation.

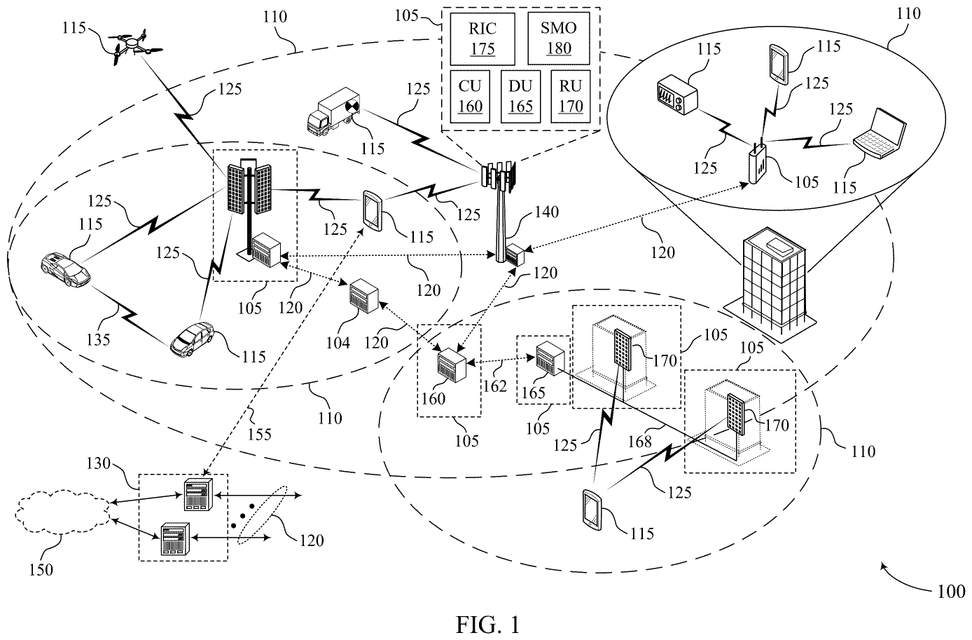

FIG. 1 shows an example of a wireless communications system 100 that supports link monitoring across multiple-cells for multi-carrier operation in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

In the case of the techniques described herein applied in the context of a disaggregated RAN architecture, one or more components of the disaggregated RAN architecture may be configured to support link monitoring across multiple-cells for multi-carrier operation as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

In some examples, such as in a carrier aggregation configuration, a carrier may have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different RAT).

The communication link(s) 125 of the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular RAT (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δƒ) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δƒₘₐₓ·N_{ƒ}) seconds, for which Δƒₘₐₓ may represent a supported subcarrier spacing, and N_{ƒ} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{ƒ}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID)). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a network entity 105 operating with lower power (e.g., a base station 140 operating with lower power) relative to a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or more cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by a transmitting device (e.g., a network entity 105 or a UE 115) along a single beam direction (e.g., a direction associated with the receiving device, such as another network entity 105 or UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a transmitting device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

In some cases, the UE 115 may detect or declare RLF. In some cases, after detection of RLF, the UE 115 may perform connection re-establishment. For example, the UE 115 may perform a random access channel (RACH) procedure. A message 3 (e.g., msg3) of the RACH procedure may include a re-establishment message (e.g., RRC Connection Re-Establishment message). The UE 115-a may transmit the message 3 to a last serving cell. If the last serving cell is not applicable, the UE 115-a may send the message 3 to a neighboring cell that supports a same public land mobile network (PLMN).

If the re-establishment is successful, the UE reports RLF to a network entity 105 via a message 5 (e.g., msg 5) of the RACH procedure (e.g., RRC Connection Re-establishment message). The message 5 may include a global cell identifier of the failed cell or measurements output (reference signal received power (RSRP) or reference signal received quality (RSRQ)) of the failed cell. Providing RLF information may help the failed cell (e.g., network) update configurations of the failed cell and reduce the chance of RLF. If re-establishment fails, the UE 115 may move to an RRC_IDLE state. The UE 115 may perform cell selection and start an RRC connection establishment procedure with a new cell.

In some cases, the UE 115-a may be in a dual connectivity (DC) communication configuration. If RLF is detected for a secondary cell group (SCG), the UE 115 may report the failure to a main cell group (MCG) via control message (e.g., SCGFailureInformation IE in RRC). If RLF is detected for MCG, the UE 115 may perform connection re-establishment as described herein.

The UE 115 may perform beam failure detection (BFD) or beam failure recovery (BFR). A MAC entity may be configured by RRC (e.g., per serving cell or per BFD reference signal set) with a BFR procedure. The BFR may be used for indicating to a serving network entity 105 of a synchronization signal block (SSB) or a CSI-RS when beam failure is detected on one or more serving SSBs or one or more serving CSI-RSs. Beam failure may be detected by counting beam failure instance indicated from lower layers to the MAC entity. The overall procedure for beam recover may be similar to RLF.

The UE 115 may be configured, on a special cell or a secondary cell, with a set of reference signals (e.g., an SSB or a CSI-RS). Similar to RLF detection, a UE 115 may use measurements to calculate a block error rate (BLER), including BLER_in and a BLER_out, based on a hypothetical physical downlink control channel (PDCCH). The UE 115 may compare the BLER_in and the BLER_out against one or more thresholds. If a quantity of consecutive beam failures is above a threshold (e.g., a threshold given by beamFailureInstanceMaxCount), the UE 115 may initiate a BFR procedure.

For the BFR procedure, the UE 115 identifies a new beam from a set of beams configured by a network entity 105 (e.g., via candiateBeamRSList). The UE 115 may utilize the identified candidate beam for recovery. The UE 115 may perform BFR via performing a RACH procedure (e.g., a contention free RACH (CFRA) procedure or a contention based RACH procedure (CBRA)) or via sending a scheduling request on a physical uplink control channel (PUCCH).

For a CFRA procedure, the UE 115 may be configured with a control resource set (CORESET) and a BFR search space (e.g., SearchSpace-BFR). If the UE 115 identifies a candidate beam, a BFR request may be sent using a RACH message. The RACH message may be configured by a RACH BFR configuration (e.g., rach-ConfigBFR). The RACH message may be associated with the identified beam. The UE 115 may monitor PDCCH. A PDCCH demodulation reference signal (DMRS) may be quasi collocated (QCL) with the selected candidate beam.

For a CBRA procedure the UE 115 may not be configured with a CORESET or the BFR search space. The UE 115 may identify a beam with an RSRP above a threshold, and the UE 115 may perform a RACH procedure.

According to techniques described herein, the UE 115 may support RLM across multiple cells including the first cell and the one or more second cells. For example, the network entity 105 may configure the UE 115 with a muti-cell RLM configuration for multiple cells. The UE 115 may perform RLM on the multiple cells. For example, the first cell and the one or more second cells may transmit reference signals to the UE 115. The UE 115 may obtain channel quality metrics for multiple cells (e.g., the first cell and the one or more second cells). If a channel quality metric associated with the first cell satisfies channel switch criteria (e.g., indicates unreliable channel conditions on the first cell), the UE 115 may transmit cell switch information. The cell switch information may include information (e.g., related to the RLM or RLF) indicating a cell switch. In some examples, the cell switch information may indicate that one or more physical layer functionalities performed by the first cell are being switched to a second cell. In some examples, the cell switch information may indicate one or more second cells with channel quality metrics that satisfy a threshold (e.g., indicating reliable channel conditions on the secondary cells) that the UE 115 requests the one or more physical layer functionalities be switched to. The RLM across multiple cells may increase communication efficiency and decrease latency associated with handover procedures and RLF procedures.

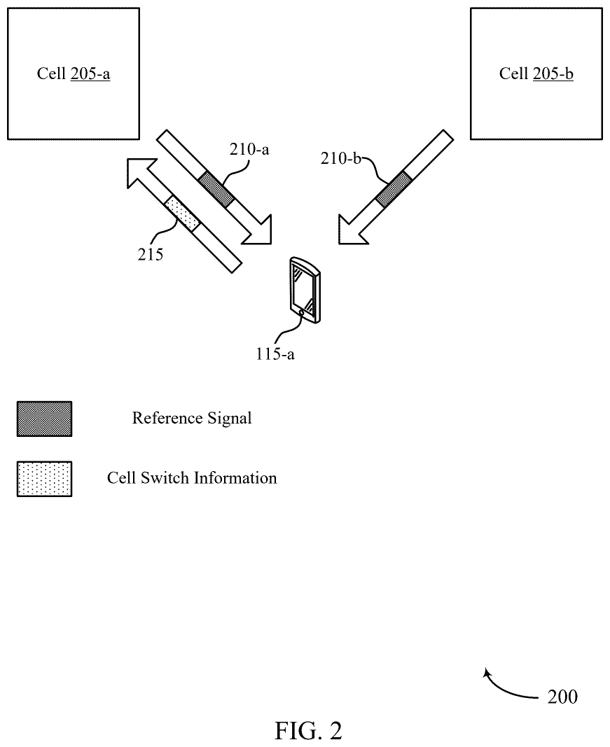

FIG. 2 shows an example of a wireless communications system 200 that supports link monitoring across multiple-cells for multi-carrier operation in accordance with one or more aspects of the present disclosure. In some examples, wireless communications system 200 may implement aspects of wireless communications system 100. For example, a UE 115-a may represent an example of a UE, such as the UEs 115 described with reference to FIG. 1. The UE 115-a may communicate with multiple cells 205. For example, the UE 115-a may communicate with a first cell 205-a (e.g., a primary cell) and one or more second cells 205-b (e.g., a secondary cell). The first cell 205-a may perform one or more physical layer functionalities (e.g., PUCCH transmission) with the UE 115-a. In some cases, the first cell 205-a and the second cell 205-b may be implemented by a same network entity 105. In some cases, the first cell 205-a and the second cell 205-b may be implemented by different network entities 105.

The UE 115-a may be configured to perform carrier aggregation with the first cell 205-a and the second cell 205-b. Carrier aggregation may be used to aggregate spectrum, in downlink or uplink, from within a same frequency band or different frequency bands. For example, the UE 115-a may be configured to transmit uplink data or receive downlink data via component carriers served by the first cell 205-a or component carriers served by the second cell 205-b. All component carriers aggregated for the UE 115-a may be controlled by a single MAC entity (e.g., a single scheduler).

The scheduler may leverage a more reliable component carriers to carry downlink or uplink data to increase communications reliability. Carrier aggregation may extend the bandwidth (e.g., the footprint) of downlink by sending uplink control data on a robust component carrier. A single scheduler may allow for cross-component carrier scheduling. The cross-component scheduling may improve physical downlink control channel (PDCCH) reliability and increase power savings at the UE 115-a.

In some cases, carrier aggregation may include a strict differentiation between the functionalities of a primary cell 205 and a secondary cell 205. After cell selection (e.g., reselection), the UE 115-a may camp on a cell 205 (e.g., monitoring for paging). If the UE 115-a is paged or if the UE 115-a has data to transmit, the UE 115-a may perform procedures to enter an RRC connected state. In the RRC connected state, the cell 205 on which the UE 115-a has been camping on becomes the primary cell 205. In the RRC connected state, a network entity 105 may add or configure more cells 205 (e.g., secondary cells 205) in downlink and uplink to increase throughput.

The UE 115-a may perform RLM on the primary cell 205. For example, a physical layer of the UE 115-a may monitor a downlink radio link quality of the primary cell for the purpose of indicating an out of sync (OoS) status or an in sync (IS) status to higher layers of the UE 115-a. In some cases, the UE 115-a may not monitor the downlink radio link quality in downlink BWPs other than an active downlink BWP on the primary cell 205.

The UE 115-a may be configured for each downlink BWP of a special cell (e.g., for both cell groups) with a set of resource indexes for RLM included in a list of reference signals (e.g., failureDetectionResources). The UE 115-a may perform RLM for each downlink BWP of the special cell through a corresponding set of RLM reference signals (e.g., a set of reference signals corresponding to RadioLinkMonitoringRS). A RLM reference signal configuration (RadioLinkMonitoringRS) may indicate an identifier of a set of RLM reference signals, a type of RLM reference signal (e.g., beam failure or RLF), a resource index (a SSB index or non-zero power CIS-RS resource identifier).

The list of reference signal (e.g., failureDetectionResourcesToAddModList) may include reference signals for detecting beam failure or cell level RLF. The network may configure at two or less detection resources (e.g., detectionResources) per BWP for detecting beam failure (e.g., beamFailure). If no reference signals are provided for the purpose of beam failure detection, the UE 115-a may perform beam monitoring based on an activated transmission control indicator (TCI) state for PDCCH. If no reference signals are provided in the list for the purpose of RLF detection, the UE 115-a may perform cell RLM based on an active TCI state of PDCCH. A network entity 105 may configure the UE 115-a with a suitable set of reference signals for performing cell RLM. If a first list of reference signals (e.g., failureDetectionSet1-r17) and a second list of reference signals (e.g., failureDectionSet2-r17) are configured, the type of RLM reference signal for each RLM reference signal configuration (e.g., RadioLinkMonitoringRS) may be set to RLF.

Based on the configured RLM RSs (e.g., SSBs or CSI-RSs), the UE 115-a may calculate one or more channel quality metrics (e.g., signal to interference and noise ratio (SINR). The UE 115-a may map the channel quality metrics to a hypothetical PDCCH BLER. The UE 115-a may categorize a status of the channel quality based on the BLER. For example, a first BLER (e.g., BLER_in, such as 2%) may correspond to IS (IS) channel conditions and a second BLER (e.g., BLER_out. Which may be greater than BLER_in) may correspond to OoS channel conditions. The hypothetical PDCCH may be a downlink control information (DCI) of DCI format 1_0 with a control channel element (CCE) aggregation level (AL) of 4 within a control resource set (CORESET) spanning 2 symbols. The UE 115-a may compare the BLERs with thresholds for IS (e.g., Qin threshold) and OoS (e.g., Qout threshold) to generate IS indicators or OoS indicators. The IS indicators or the OoS indicators may be passed from the physical layer of the UE 115-a to the higher layers of the UE 115-a.

In some cases, the UE 115-a may be configured with multiple reference signals for RLM. The UE 115-a may trigger an OoS indication if the channel quality metric is worse than the Qout threshold for each RLM reference signals. The UE 115-a may trigger an IS indication if the channel quality metric of at least one RLM reference signal is better than the Qin threshold.

A network entity 105 may configure the UE 115-a with a set of timer values or thresholds (e.g., N310, T310, and N311) via a timer configuration (e.g., rlf-TimersAndConstants RRC IE). A first threshold quantity (e.g., N310) may indicate a quantity of consecutive OoS indications to start a first timer (e.g., T310). The first timer may count until the first timer expires, triggering a RLF detection. For example, RLF may be detected when the first timer expires, indicating the link is unstable. A second threshold quantity may indicate a quantity of consecutive IS indications to stop and reset the timer (e.g., T310).

A value of the first threshold quantity (e.g., N310) may be configured as 1, 2, 3, 4, 5, 8, 10, or 20. A value or duration of the first timer (e.g., T310) may be configured via the first timer configuration. For example, a duration of the first timer may be configured as 0 ms, 50 ms, 100 ms, 200 ms, 500 ms, 1000 ms, 2000 ms, 4000 ms, or 6000 ms. A value of the second threshold quantity (e.g., N311) may be configured as 1, 2, 3, 4, 5, 6, 8, or 10.

In some cases, the primary cell 205 may not be the most reliable cell 205. For example, cells 205 with a wider channel bandwidth (e.g., TDD cells 205 in a frequency band, such as C-band) may be prioritized for access over cells 205 with a narrow channel bandwidth (e.g., low-band FDD cells 205). When the primary cell becomes unreliable, the UE 115-a may declare RLF or the UE 115-a may be handed over to another cell 205 (e.g., an FDD cell 205).

Declaring RLF or performing a handover (HO) procedure may be relatively slow and cause interruptions to the ongoing services. The primary cell 205 may become unreliable before other cells 205. It may be beneficial for the UE 115-a to be able to switch the functionalities of the primary cell 205 to a secondary cell 205 instead of performing the full RLF or going through HO procedure. For example, the UE 115-a may select a more reliable cell to serve as the primary cell 205.

According to techniques described herein, the UE 115-a may perform RLM across different cells 205. The UE 115 may be configured with RLM resources on multiple cells (e.g., the first cell 205-a and the second cell 205-b). If the first timer (e.g., T310) expires, the UE 115-a may switch the primary cell 205 to another cell 205 or switch some of the physical layer functionalities of the primary cell 205 (e.g., PUCCH transmission) to another cell 205. In some cases, the UE 115-a may receive an indication to switch the primary cell 205 to another cell 205 or to switch some of the physical layer functionalities of the primary cell 205 to another cell 205, but may continue to perform one or more other physical layer functionalities on the primary cell 205.

For example, the first cell 205-a may be a primary cell 205 or perform one or more physical layer functionalities. The UE 115-a may receive a control message indicating a first set of RLM reference signals 210-a transmitted by the first cell 205-a and a second set of RLM reference signals 210-b transmitted by the second cell 205-b. The first timer may expire for the first cell 205, and the UE 115-a may transmit cell switch information 215 indicating that physical layer functionalities of the primary cell 205 are switched to the second cell 205. The techniques described herein for RLM and RLF detection may be an example of a UE triggered switching.

The UE 115-a may be configured with (e.g., receiving control signaling from a network entity) a reference signal sets for RLM on multiple cells 205 (e.g., on a primary cell 205 as well as one more secondary cells 205). A reference signal set may indicate one or more time-frequency resources associated with a cell for receiving, for example, reference signal signaling. The configuration of each reference signal set may be independent from, the same as, or partially dependent on one or more other configured reference signal sets. For example, the reference signal configurations, PDCCH assumptions (e.g., the hypothetical PDCCH configuration), BLER_in and BLER_out, and timers (N310, N311, T310) may be the same across cells 205 or separately (e.g., independently) indicated (e.g., in control signaling transmitted by a network entity).

In some cases, the UE 115-a may be configured or indicated (e.g., in control signaling transmitted by a network entity) to perform RLM one cell at a time (e.g., in a sequential order indicated by a network entity 105 in control signaling). In some cases, the UE 115-a may be configured to perform indicated (e.g., in control signaling transmitted by a network entity) RLM simultaneously on multiple (e.g., all) configured cells 205. Performing RLM simultaneously may be defined as performing RLM for the multiple cells 205 over a duration.

In some examples, the UE 115-a may perform RLM simultaneously conditionally (e.g., when one or more conditions are met). The conditions may be based on the measurements performed by the UE 115-a and configured RSRP or BLER thresholds. As used herein, the term configured may refer to one or more instructions indicating by control signaling transmitted by a network entity or specified in a wireless standard. In an example, the UE 115-a may first perform RLM on the first cell 205-a (e.g., the primary cell 205). If a channel quality metric (e.g., BLER_in, BLER_out, a quantity of IS indications, a quantity of OoS indications, a ratio of quantity of IS indications to a quantity of OoS indications, RSRP measurement(s), or any combination thereof) satisfies a channel quality threshold (e.g., indicating that signal quality of the primary cell is satisfactory for wireless communication), the UE 115-a may not perform RLM on other cells 205 (e.g., the second cell 205-b).

If the channel quality metric does not satisfy the channel quality threshold (e.g., indicating that signal quality of the primary cell is poor), the UE 115-a may start performing RLM on one or more other cells 205 (e.g., the second cell 205-b). The UE 115-a may optionally continue performing RLM on the first cell 205-a as well.

When the conditions for multi-cell RLM are satisfied (e.g., the channel quality metric of the first cell 205-a does not satisfy the channel quality threshold), the UE 115-a may perform RLM on one or more other cells 205 or a group of cells 205 at a time (e.g., start monitoring one or more secondary cells or a group of cells sequentially, concurrently, or simultaneously). If the channel quality metric of the first cell 205-a does not satisfy the threshold, the UE 115-a may perform RLM on a first set of one or more component carriers (e.g., served by the second cell 205-b). If a channel quality metric of the first set of component carriers does not satisfy the threshold, the UE 115-a may perform RLM on the first cell 205-a, on the first set of component carriers, and a second set of one or more component carriers (e.g., served by an additional cell 205).

In some cases, the UE 115-a may perform RLM on target component carriers (e.g., all other target component carriers) simultaneously in addition to performing RLM on the first cell 205-a. For example, the UE 115-a may perform RLM on up to all other target component carriers simultaneously in addition to performing RLM on a primary cell. In some examples, the network entity 105 may transmit control signaling that includes an indication of a quantity of cells 205 to monitor corresponding to the target component carriers. The network entity 105 may indicate behaviors or procedures to follow after one or more conditions for each component carrier or the set of component carriers is satisfied (e.g., if one or more channel quality metrics of a component carrier or the set of component carriers do not satisfy the component carrier threshold).

If the UE 115-a is configured with multiple cells 205 for RLM, the UE 115-a may be configured with a set of timer values or thresholds. For example, the UE 115-a may be configured with the first timer (e.g., T310), the first threshold quantity (e.g., N310), or the second threshold quantity (e.g., N311), as described herein. Additionally, or alternatively, the UE 115-a may be configured with a second timer (e.g., T310′) a third threshold quantity (e.g., N310′), or a fourth threshold quantity (e.g., N311′). The third threshold quantity may indicate a quantity of consecutive OoS indications to start the second timer T310′. In some cases, the second timer may count until expiration, triggering RLM on another cell 205 (e.g., if RLM is done on the cells 205 sequentially or one at a time). In some cases, the second timer may count until expiration, triggering the UE 115-a to switch to another cell 205 (e.g., to switch from a primary cell to a secondary cell) for one or more physical functionalities (e.g., if the RLM is performed on the cells 205 simultaneously). The fourth threshold may indicate a quantity of consecutive IS indications to stop and reset the second timer.

For example, the UE 115-a may be configured with RLM for the first cell 205-a and the second cell 205-b. The UE 115-a may perform one or more physical layer functionalities with the first cell 205-a. If RLM is done sequentially, after expiry of (e.g., T310′), the UE 115-a may monitor one or more RLM reference signals on the second cell 205-b. The second cell 205-b may be indicated by a network entity 105 or selected by the UE 115-a from a set of potential cells 205. The set of potential cells 205 may be configured with RLM reference signals.

If RLM is done simultaneously on multiple cells 205, after the expiry of the second timer (e.g., T310′) on the first cell 205-a, the UE 115-a may switch to the second cell 205-b (e.g., for a set of physical layer related procedures or functionalities such as PUCCH). In some cases, the second cell 205-b may be a next cell 205 in a set of cells 205 that a network entity 105 has indicated for RLM and is not in failure (e.g., that is viable). In some cases, the second cell 205-b may be selected by the UE 115-a. For example, where the UE 115-a is performing RLM simultaneously on multiple cells, after the expiry of T310′ on the current cell, the UE 115-a switches to another cell (for a set of PHY related procedures such as PUCCH). The next cell could be the next cell in the set of cells that a network entity 105 has indicated for RLM and is not in failure or the UE 115-a may autonomously select the next cell of a set of cells for RLM.

The UE 115-a may switch from the first cell 205-a to the second cell 205-b based on the channel quality metric (e.g., RLM metrics) of the first cell 205-a not satisfying the channel quality threshold. In some cases, the UE 115-a may stop RLM on the first cell 205-a after switching. In some cases, the UE 115-a may continue RLM on the first cell 205-a even after switching. The channel quality metrics of the first cell 205-a satisfy the channel quality threshold again, the first cell 205-a may be considered as a candidate cell (e.g., potential cell) for performing RLM (e.g., and a potential cell for bearing the primary cell 205 functionalities).

The UE 115-a configured with a multi-cell RLM may declare RLF if all cells 205 configured with RLM reference signals have been failed. If at least one cell has not been failed, the UE 115-a may not declare RLF. The procedure may be as follows, the UE 115-a may perform BFD and BFR in a cell 205. If BFR is unsuccessful, the UE 115-a may perform cell RLM and cell RLF. If RLF is unsuccessful, the UE 115-a may perform multi-cell RLM. The UE 115-a may perform RLF declaration if all cells 205 fail (e.g., if channel quality metrics for the first cell 205-a and the second cell 205-b do not satisfy the channel quality threshold).

In some cases, the UE 115-a may include a counter that applies to all cells 205. If all cells 205 have been failed, the counter may starts running. If the counter expires, the UE 115-a may declare RLF. When the counter is running, if at least one cell 205 satisfies the channel quality threshold (e.g., the RLM requirements), the UE 115-a may not declare RLF. Instead, the UE 115-a may select that cell 205 as the new primary cell 205 (e.g., switch physical layer functionalities to the selected cell 205).

The UE 115-a may switch to another cell based on the channel quality metric of the first cell 205-a satisfying cell switch criterion. For example, the UE 115-a may switch to the second cell based on a channel quality metric of the first cell not satisfying the channel quality threshold and based on a channel quality metric of the second cell satisfying the channel quality threshold. When the UE 115-a switches to another cell 205 (e.g., either to start RLM or selecting another cell 205 as to perform primary cell related physical layer functionalities), the UE 115-a may inform the network entity 105 about the switch.

In some examples, the UE 115-a may be configured by the network entity 105 (e.g., via control signaling) with PUCCH resources, a CFRA RACH configuration, a CBRA RACH configuration, or any combination thereof, to inform the network entity 105 about the UE 115-a switching to another cell 205. The resources may be configured on the first cell 205-a (e.g., the primary cell 205), on each cell 205 configured for RLM separately, on any other cell 205 (e.g., an additional cell 205), on multiple cells 205, or any combination thereof.

If the resources are configured on the additional cell 205, for CFRA, the RACH resources on the additional cell 205 may be partitioned to indicate which cell 205 the UE 115-a has switched to. For example, the additional cell 205 (e.g., cell #X) may include resources for switching to the additional cell 205 (e.g., cell #X), the first cell 205-a (e.g., cell #Y), or the second cell 205-b (e.g., cell #Z).

In some cases, for CBRA, the RACH messages may be partitioned to indicate which cell 205 the UE 115-a has switched to. In some cases, for CBRA, the UE 115-a may indicate to the network entity 105 which cell 205 the UE 115-a has switched to in messages of RACH procedure (e.g., message 3).

In some cases, the UE 115-a may not identify a suitable beam (e.g., unlink BFR). The beam associated with RACH resource and the PDCCH for message 2 reception may be based on the serving beam on the target cell. Additionally, or alternatively, the UE 115-a may identify a suitable SSB on the target cell 205 (e.g., switching target) and then select the RACH resources associated with that SSB. The UE 115-a may identify the suitable SSB if the target cell is inactive and the UE 115-a is performing inactive cell measurements (e.g., inactive secondary cell measurements.

The UE 115-a may identify the next RLM cell (e.g., the second cell 205-b). If the UE 115-a is configured with (e.g., via control signaling received from the network entity 105) a set of configurations for physical layer related procedures (e.g., PUCCH transmission or PDCCH monitoring, for some formats) on the second cell 205-b, the configurations may be active. For example, the UE 115-a may perform operations (e.g., physical layer functionality) on the second cell 205-b in accordance with a first configuration of the next RLM cell from the set of configurations. The UE may perform the operation on the next RLM after a duration (e.g., a quantity of slots after a UE 115-a notified the network entity 105) in accordance with the first configuration.

In some cases, the UE 115-a may report (e.g., via transmission of a control message) the decision to switch to another cell 205 to the network entity 105. The UE 115-a may indicate a cell 205 (e.g., explicitly or implicitly indicate the second cell 205-b) or indicate that the UE request to switch to a different cell 205 (e.g., and the network entity 105 may select the cell, such as the second cell 205). In some cases, the network entity 105 may activate one or more operations on the second cell 205-b (e.g., in case the UE 115-a is preconfigured with one or more communication parameters for the second cell 205-b, such as a first configuration of the next RLM cell from the set of configurations previously indicated in control signal received from the network entity 105). In some cases, the network entity 105 may configure the UE 115 with communication parameters (e.g., transmit control signaling indicating the communication parameters) for the second cell 205-b in response to the reported decision by the UE 115-a. In some cases, the network entity 105 may, in response to the reported decision, select a different cell 205 and instruct the UE to switch to the different cell 205.

In some cases (e.g., instead of the UE 115-a informing the network entity 105 as to which cell 205 the UE 115-a requests to switching to), the UE 115-a may report a list of one or more cells 205 that each satisfy one or more channel quality metrics (e.g., pass RLM requirements). The UE 115-a may include one or more cell measurements, one or more cell statistics of OoS or IS indications, etc., or any combination thereof. In response, the network entity 105 may choose a cell from the list of one or more cells 205, and the network entity 105 may transmit an indication of the selected cell 205 to the UE 115-a.

The UE 115-a may support multi-cell RLM. In some cases, the UE 115-a may indicate (e.g., via transmission of control signaling to the network entity 105) a quantity of cells that the UE 115-a supports for performing RLM. The UE 115-a may also indicate if the UE 115-a supports sequential RLM (e.g., performing RLM one at a time on a set of cells) or concurrent RLM (e.g., capability of performing RLM simultaneously on two or more cells). In response, the network entity 105 may transmit a control message indicating a multi-cell RLM configuration in accordance with the UE capability (e.g., configure the UE to perform sequential or concurrent RLM).

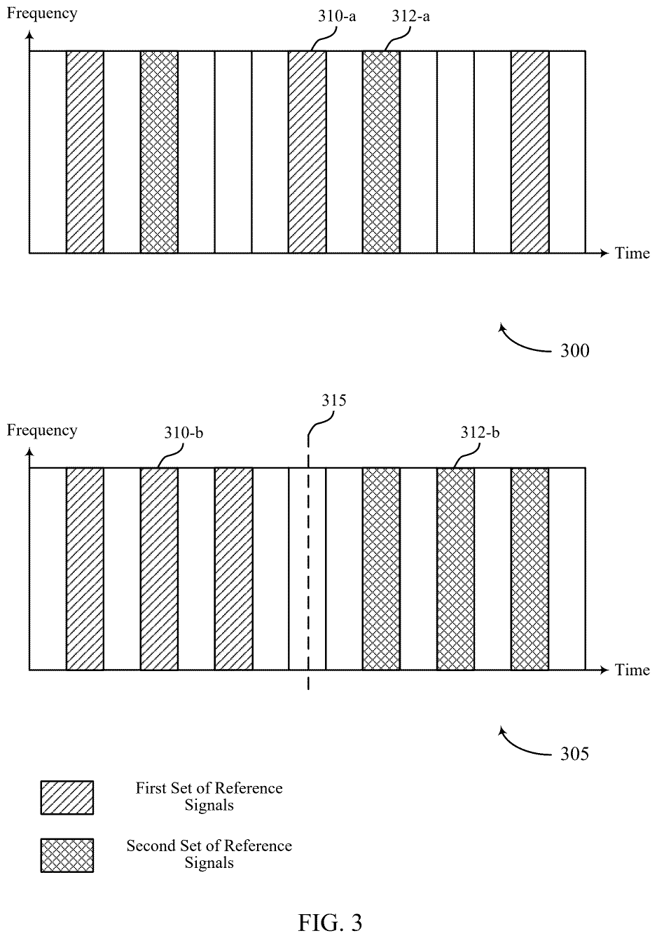

FIG. 3 shows examples of a first resource timeline 300 and a second resource timeline 305 that supports link monitoring across multiple-cells for multi-carrier operation in accordance with one or more aspects of the present disclosure. In some examples, the first resource timeline 300 and the second resource timeline 305 may implement aspects of wireless communications system 100 and wireless communications system 200. For example, the first resource timeline 300 or the second resource timeline 305 may be implemented by a UE such as a UE 115, as described with reference to FIGS. 1 and 2. The UE 115 may receive one or more reference signals of a first set of reference signals 310 transmitted by a first cell (e.g., the first cell 205-a as described with reference to FIG. 2). The UE 115 may receive one or more reference signals of a second set of reference signals 312 transmitted by a second cell (e.g., the second cell 205-b as described with reference to FIG. 2).

As illustrated in the first resource timeline 300, a network entity 105 may configure the UE 115 to perform concurrent RLM, as described with reference to FIG. 2. The UE 115 may be configured to receive RLM reference signals from the first set of reference signals 310 and the second set of reference signals 312. For example, the UE 115 may receive alternating or periodic the reference signals from the first set of reference signals 310 and the second set of reference signals 312. The UE 115 may receive a first reference signal 310-a of the first set of reference signals, and the UE 115 may receive a second reference signal 312-a of the second set of reference signals 312.

As illustrated in the second resource timeline 305, a network entity 105 may configure the UE 115 to perform sequential RLM (e.g., one at a time RLM), as described with reference to FIG. 2. For example, the UE 115 may be configured to receive RLM reference signals from the first set of reference signals 310. At 315, the UE may detect that a channel quality metric of the first cell does not satisfy a channel quality threshold. After 315, the UE 115 may receive RLM reference signals from the second set of reference signals 312. For example, the UE 115 may receive a first reference signal 310-b of the first set of reference signals 310, and the UE may receive a second reference signal 312-b of the second set of reference signals 312.

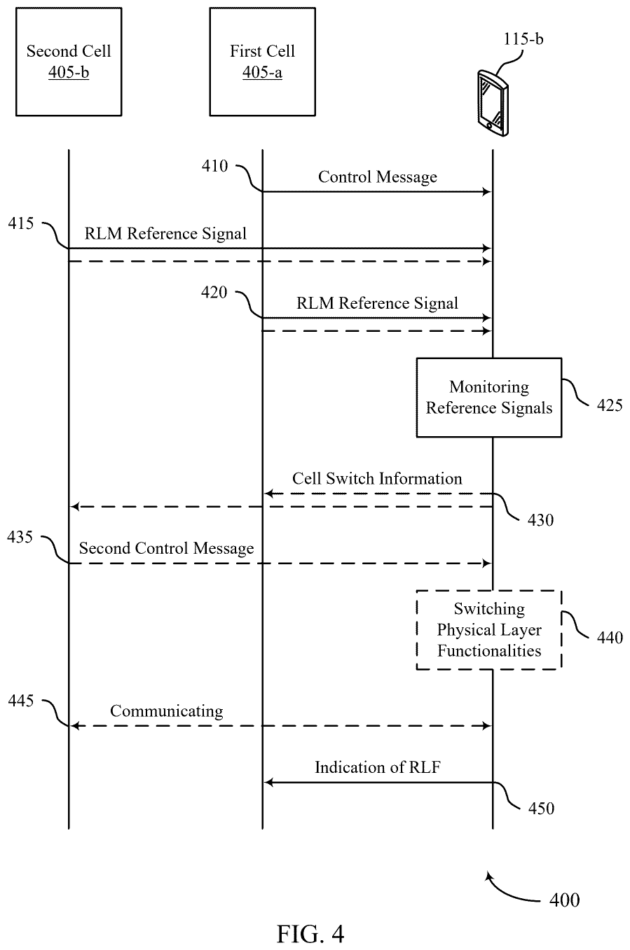

FIG. 4 shows an example of a process flow 400 that supports link monitoring across multiple-cells for multi-carrier operation in accordance with one or more aspects of the present disclosure. In some examples, process flow 400 may implement aspects of wireless communications system 100, wireless communications system 200, first resource timeline 300, or second resource timeline 305. For example, the process flow 400 may include a UE 115-b, a primary cell 405-a (e.g., the first cell 205-a as described with reference to FIG. 2), and a secondary cell 405-b (e.g., the second cell 205-b as described with reference to FIG. 2) which may be examples of corresponding devices described with reference to FIGS. 1-3. The primary cell 405-a and the secondary cell 405-b may be implemented by a same network entity 105, as described with reference to FIG. 1, or multiple network entities 105. Although the steps described in process flow 400 are illustrated as originating from the cells 405, it should be understood that the steps described in process flow 400 may be performed by one or more network entities 105.

At 410, the UE 115-b may receive a control message indicating a multi-cell RLM configuration for multiple cells 405 including a primary cell 405-a and at least one secondary cell 405-b. The multi-cell RLM configuration may indicate multiple reference signal sets for monitoring the multiple cells. The multi-cell RLM configuration may configure the UE 115-b to perform multi-cell RLM operation as discussed herein.

At 415, the primary cell 405-a may transmit a first set of RLM reference signals via a first reference signal set of the multiple reference signal sets. At 420, the secondary cell 405-b may transmit a second set of RLM reference signals via a second reference signal set of the multiple reference signal sets.

At 425, the UE 115-b may monitor the multiple reference signal sets to obtain a first channel quality metric associated with the primary cell 405-a and one or more second channel quality metrics associated with the at least one secondary cell 405-b in accordance with the multi-cell RLM configuration. In some cases, the UE 115-b may monitor a first reference signal set of the multiple reference signal sets to obtain the first channel quality metric associated with the primary cell 405-a. The UE 115-b may monitor, based on the first channel quality metric satisfying the cell switch criterion, a second reference signal set of the multiple reference signal sets to obtain the one or more second channel quality metrics.

In some cases, the UE 115-b may receive an indication of the secondary cell 405-b of the at least one secondary cell 405. The UE 115-b may monitor the second reference signal set based on the indication of the secondary cell 405-b.

In some cases, the UE 115-b may detect a quantity of OoS indications that occur prior to a monitoring window (e.g., time duration). The UE 115-b may detect a quantity of IS indications that occur during the monitoring window. The first channel quality metric may satisfy the cell switch criterion based on the quantity of OoS indications satisfying a first threshold and the quantity of IS indications satisfying a second threshold.

At 430, the UE 115-b may transmit cell switch information based on the first channel quality metric satisfying a cell switch criterion and the one or more second channel quality metrics. The UE 115-b may transmit the cell switch information to the primary cell 405-a, the secondary cell 405-b, or another cell 405.

In some cases, at 430, the UE 115-b may transmit, via uplink resources indicated by the multi-cell RLM configuration, an indication that one or more physical layer functionalities have been switched from the primary cell 405-a to the secondary cell 405-b of the at least one secondary cell 405. The uplink resources may be associated with the secondary cell 405-b. In some cases, the UE 115-b may transmit an indication of a beam associated with the secondary cell 405-b based on a beam quality metric associated with the beam.

In some cases, at 430, the UE 115-b may transmit an indication of one or more secondary cells 405 of the at least one secondary cell 405. Each second channel quality metric of the one or more second channel quality metrics associated with the one or more secondary cells 405 may satisfy a threshold.

In some cases, at 435, the UE 115-b may receive, based on the cell switch information, a second control message indicating a communication configuration for the secondary cell 405-b of the at least one secondary cell 405. In some cases, at 435, the UE 115-b may receive an indication of the secondary cell 405-b of the one or more secondary cells 405 based on the indication of the one or more secondary cells 405.

At 440, the UE 115-b may switch one or more physical layer functionalities from the primary cell 405-a to the secondary cell 405-b of the at least one secondary cell 405 based on the first channel quality metric satisfying the cell switch criterion. In some cases, the UE 115-b may refrain, after switching the one or more physical layer functionalities from the primary cell 405-a to the secondary cell 405-b, from monitoring a first reference signal set of the multiple reference signal sets based on the first channel quality metric satisfying the cell switch criterion. In some cases, the UE 115-b may monitor, after switching the one or more physical layer functionalities from the primary cell to the secondary cell, a first reference signal set of the multiple reference signal sets. The first reference signal set may be associated with the primary cell 405-a.

At 445, the UE 115-b may communicate, via the secondary cell 405-b, one or more messages associated with the one or more physical layer functionalities. The UE 115-b may communicate, via the secondary cell 405-b, one or more messages in accordance with the communication configuration. The UE 115-b may communicate, via the secondary cell 405-b, one or more messages based on the indication of the secondary cell 405-b.

At 450, the UE 115-b may transmit an indication of RLF based on the first channel quality metric satisfying the cell switch criterion and the one or more second channel quality metrics satisfying a RLF threshold.

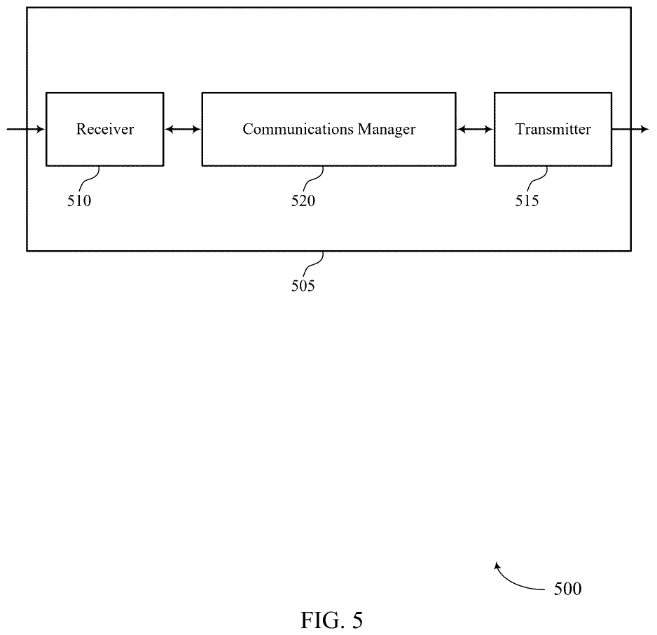

FIG. 5 shows a block diagram 500 of a device 505 that supports link monitoring across multiple-cells for multi-carrier operation in accordance with one or more aspects of the present disclosure. The device 505 may be an example of aspects of a UE 115 as described herein. The device 505 may include a receiver 510, a transmitter 515, and a communications manager 520. The device 505, or one or more components of the device 505 (e.g., the receiver 510, the transmitter 515, the communications manager 520), may include at least one processor, which may be coupled with at least one memory, to, individually or collectively, support or enable the described techniques. Each of these components may be in communication with one another (e.g., via one or more buses).

The receiver 510 may provide a means for receiving information such as packets, user data, control information, or any combination thereof associated with various information channels (e.g., control channels, data channels, information channels related to link monitoring across multiple-cells for multi-carrier operation). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to link monitoring across multiple-cells for multi-carrier operation). In some examples, the transmitter 515 may be co-located with a receiver 510 in a transceiver module. The transmitter 515 may utilize a single antenna or a set of multiple antennas.

The communications manager 520, the receiver 510, the transmitter 515, or various combinations or components thereof may be examples of means for performing various aspects of link monitoring across multiple-cells for multi-carrier operation as described herein. For example, the communications manager 520, the receiver 510, the transmitter 515, or various combinations or components thereof may be capable of performing one or more of the functions described herein.

In some examples, the communications manager 520, the receiver 510, the transmitter 515, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 520, the receiver 510, the transmitter 515, or various combinations or components thereof may be implemented in code (e.g., as communications management software or firmware) executed by at least one processor (e.g., referred to as a processor-executable code). If implemented in code executed by at least one processor, the functions of the communications manager 520, the receiver 510, the transmitter 515, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 520 may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communications in accordance with examples as disclosed herein. For example, the communications manager 520 is capable of, configured to, or operable to support a means for receiving a control message indicating a multi-cell RLM configuration for a set of multiple cells including a primary cell and at least one secondary cell, the multi-cell RLM configuration indicating a set of multiple reference signal sets for monitoring the set of multiple cells. The communications manager 520 is capable of, configured to, or operable to support a means for monitoring the set of multiple reference signal sets to obtain a first channel quality metric associated with the primary cell and one or more second channel quality metrics associated with the at least one secondary cell in accordance with the multi-cell RLM configuration.

By including or configuring the communications manager 520 in accordance with examples as described herein, the device 505 (e.g., at least one processor controlling or otherwise coupled with the receiver 510, the transmitter 515, the communications manager 520, or a combination thereof) may support techniques for more efficient utilization of communication resources and the like.

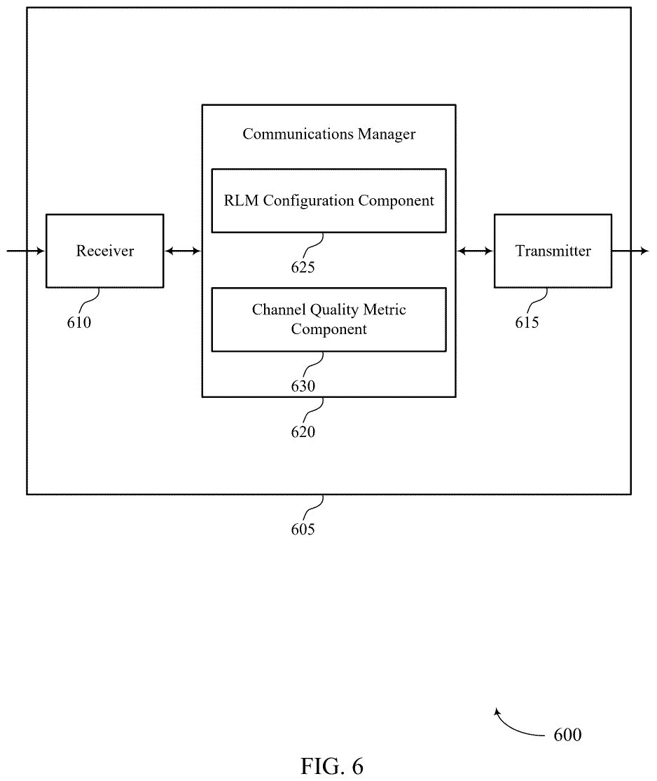

FIG. 6 shows a block diagram 600 of a device 605 that supports link monitoring across multiple-cells for multi-carrier operation in accordance with one or more aspects of the present disclosure. The device 605 may be an example of aspects of a device 505 or a UE 115 as described herein. The device 605 may include a receiver 610, a transmitter 615, and a communications manager 620. The device 605, or one or more components of the device 605 (e.g., the receiver 610, the transmitter 615, the communications manager 620), may include at least one processor, which may be coupled with at least one memory, to support the described techniques. Each of these components may be in communication with one another (e.g., via one or more buses).

The receiver 610 may provide a means for receiving information such as packets, user data, control information, or any combination thereof associated with various information channels (e.g., control channels, data channels, information channels related to link monitoring across multiple-cells for multi-carrier operation). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to link monitoring across multiple-cells for multi-carrier operation). In some examples, the transmitter 615 may be co-located with a receiver 610 in a transceiver module. The transmitter 615 may utilize a single antenna or a set of multiple antennas.

The device 605, or various components thereof, may be an example of means for performing various aspects of link monitoring across multiple-cells for multi-carrier operation as described herein. For example, the communications manager 620 may include an RLM configuration component 625 a channel quality metric component 630, or any combination thereof. The communications manager 620 may be an example of aspects of a communications manager 520 as described herein. In some examples, the communications manager 620, or various components thereof, may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communications in accordance with examples as disclosed herein. The RLM configuration component 625 is capable of, configured to, or operable to support a means for receiving a control message indicating a multi-cell RLM configuration for a set of multiple cells including a primary cell and at least one secondary cell, the multi-cell RLM configuration indicating a set of multiple reference signal sets for monitoring the set of multiple cells. The channel quality metric component 630 is capable of, configured to, or operable to support a means for monitoring the set of multiple reference signal sets to obtain a first channel quality metric associated with the primary cell and one or more second channel quality metrics associated with the at least one secondary cell in accordance with the multi-cell RLM configuration.

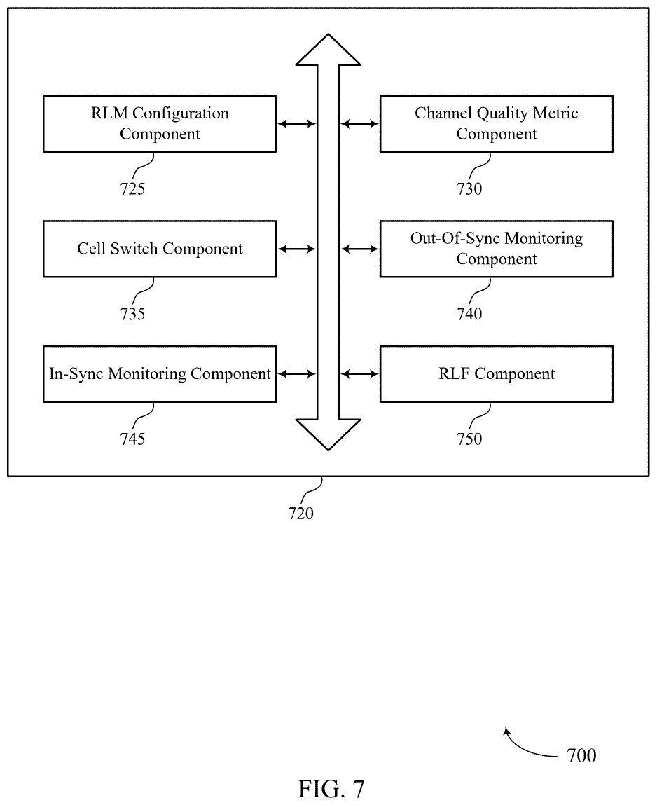

FIG. 7 shows a block diagram 700 of a communications manager 720 that supports link monitoring across multiple-cells for multi-carrier operation in accordance with one or more aspects of the present disclosure. The communications manager 720 may be an example of aspects of a communications manager 520, a communications manager 620, or both, as described herein. The communications manager 720, or various components thereof, may be an example of means for performing various aspects of link monitoring across multiple-cells for multi-carrier operation as described herein. For example, the communications manager 720 may include an RLM configuration component 725, a channel quality metric component 730, a cell switch component 735, an OoS monitoring component 740, an IS monitoring component 745, an RLF component 750, or any combination thereof. Each of these components, or components or subcomponents thereof (e.g., one or more processors, one or more memories), may communicate, directly or indirectly, with one another (e.g., via one or more buses).

The communications manager 720 may support wireless communications in accordance with examples as disclosed herein. The RLM configuration component 725 is capable of, configured to, or operable to support a means for receiving a control message indicating a multi-cell RLM configuration for a set of multiple cells including a primary cell and at least one secondary cell, the multi-cell RLM configuration indicating a set of multiple reference signal sets for monitoring the set of multiple cells. The channel quality metric component 730 is capable of, configured to, or operable to support a means for monitoring the set of multiple reference signal sets to obtain a first channel quality metric associated with the primary cell and one or more second channel quality metrics associated with the at least one secondary cell in accordance with the multi-cell RLM configuration.

In some examples, the cell switch component 735 is capable of, configured to, or operable to support a means for transmitting cell switch information based on the first channel quality metric satisfying a cell switch criterion and the one or more second channel quality metrics.

In some examples, to support monitoring the plurality of reference signal sets, the cell switch component 735 is capable of, configured to, or operable to support a means for monitoring a first reference signal set of the set of multiple reference signal sets to obtain the first channel quality metric associated with the primary cell. In some examples, to support monitoring the plurality of reference signal sets, the cell switch component 735 is capable of, configured to, or operable to support a means for monitoring, based on the first channel quality metric satisfying the cell switch criterion, a second reference signal set of the set of multiple reference signal sets to obtain the one or more second channel quality metrics.

In some examples, the RLM configuration component 725 is capable of, configured to, or operable to support a means for receiving an indication of a secondary cell of the at least one secondary cell, where the second reference signal set is monitored based on the indication of the secondary cell.

In some examples, the OoS monitoring component 740 is capable of, configured to, or operable to support a means for detecting a quantity of OoS indications that occur prior to a monitoring window. In some examples, the IS monitoring component 745 is capable of, configured to, or operable to support a means for detecting a quantity of IS indications that occur during the monitoring window, where the first channel quality metric satisfies the cell switch criterion based on the quantity of OoS indications satisfying a first threshold and the quantity of IS indications satisfying a second threshold.

In some examples, the cell switch component 735 is capable of, configured to, or operable to support a means for switching one or more physical layer functionalities from the primary cell to a secondary cell of the at least one secondary cell based on the first channel quality metric satisfying the cell switch criterion. In some examples, the cell switch component 735 is capable of, configured to, or operable to support a means for communicating, via the secondary cell, one or more messages associated with the one or more physical layer functionalities.

In some examples, the channel quality metric component 730 is capable of, configured to, or operable to support a means for refraining, after switching the one or more physical layer functionalities from the primary cell to the secondary cell, from monitoring a first reference signal set of the set of multiple reference signal sets based on the first channel quality metric satisfying the cell switch criterion, where the first reference signal set is associated with the primary cell.

In some examples, the channel quality metric component 730 is capable of, configured to, or operable to support a means for monitoring, after switching the one or more physical layer functionalities from the primary cell to the secondary cell, a first reference signal set of the set of multiple reference signal sets, where the first reference signal set is associated with the primary cell.

In some examples, the RLF component 750 is capable of, configured to, or operable to support a means for transmitting an indication of RLF based on the first channel quality metric satisfying the cell switch criterion and the one or more second channel quality metrics satisfying a RLF threshold.

In some examples, to support transmitting the cell switch information, the cell switch component 735 is capable of, configured to, or operable to support a means for transmitting, via uplink resources indicated by the multi-cell RLM configuration, an indication that one or more physical layer functionalities have been switched from the primary cell to a secondary cell of the at least one secondary cell.

In some examples, the uplink resources are associated with the secondary cell.

In some examples, to support transmitting the cell switch information, the cell switch component 735 is capable of, configured to, or operable to support a means for transmitting an indication of a beam associated with the secondary cell based on a beam quality metric associated with the beam.

In some examples, the cell switch component 735 is capable of, configured to, or operable to support a means for receiving, based on the cell switch information, a second control message indicating a communication configuration for a secondary cell of the at least one secondary cell. In some examples, the cell switch component 735 is capable of, configured to, or operable to support a means for communicating, via the secondary cell, one or more messages in accordance with the communication configuration.

In some examples, to support transmitting the cell switch information, the cell switch component 735 is capable of, configured to, or operable to support a means for transmitting an indication of one or more secondary cells of the at least one secondary cell, where each second channel quality metric of the one or more second channel quality metrics associated with the one or more secondary cells satisfies a threshold.

In some examples, the cell switch component 735 is capable of, configured to, or operable to support a means for receiving an indication of a secondary cell of the one or more secondary cells based on the indication of the one or more secondary cells. In some examples, the cell switch component 735 is capable of, configured to, or operable to support a means for communicating, via the secondary cell, one or more messages based on the indication of the secondary cell.

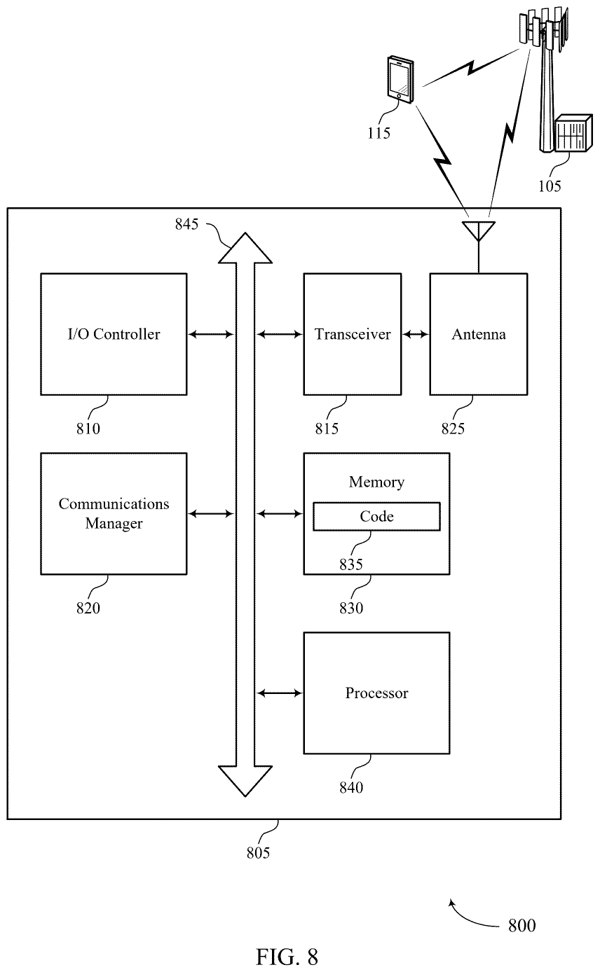

FIG. 8 shows a diagram of a system 800 including a device 805 that supports link monitoring across multiple-cells for multi-carrier operation in accordance with one or more aspects of the present disclosure. The device 805 may be an example of or include components of a device 505, a device 605, or a UE 115 as described herein. The device 805 may communicate (e.g., wirelessly) with one or more other devices (e.g., network entities 105, UEs 115, or a combination thereof). The device 805 may include components for bi-directional voice and data communications including components for transmitting and receiving communications, such as a communications manager 820, an input/output (I/O) controller, such as an I/O controller 810, a transceiver 815, one or more antennas 825, at least one memory 830, code 835, and at least one processor 840. These components may be in electronic communication or otherwise coupled (e.g., operatively, communicatively, functionally, electronically, electrically) via one or more buses (e.g., a bus 845).

The I/O controller 810 may manage input and output signals for the device 805. The I/O controller 810 may also manage peripherals not integrated into the device 805. In some cases, the I/O controller 810 may represent a physical connection or port to an external peripheral. In some cases, the I/O controller 810 may utilize an operating system such as iOS®, ANDROID®, MS-DOS®, MS-WINDOWS®, OS/2®, UNIX®, LINUX®, or another known operating system. Additionally, or alternatively, the I/O controller 810 may represent or interact with a modem, a keyboard, a mouse, a touchscreen, or a similar device. In some cases, the I/O controller 810 may be implemented as part of one or more processors, such as the at least one processor 840. In some cases, a user may interact with the device 805 via the I/O controller 810 or via hardware components controlled by the I/O controller 810.

In some cases, the device 805 may include a single antenna. However, in some other cases, the device 805 may have more than one antenna, which may be capable of concurrently transmitting or receiving multiple wireless transmissions. The transceiver 815 may communicate bi-directionally via the one or more antennas 825 using wired or wireless links as described herein. For example, the transceiver 815 may represent a wireless transceiver and may communicate bi-directionally with another wireless transceiver. The transceiver 815 may also include a modem to modulate the packets, to provide the modulated packets to one or more antennas 825 for transmission, and to demodulate packets received from the one or more antennas 825. The transceiver 815, or the transceiver 815 and one or more antennas 825, may be an example of a transmitter 515, a transmitter 615, a receiver 510, a receiver 610, or any combination thereof or component thereof, as described herein.

The at least one memory 830 may include random access memory (RAM) and read-only memory (ROM). The at least one memory 830 may store computer-readable, computer-executable, or processor-executable code, such as the code 835. The code 835 may include instructions that, when executed by the at least one processor 840, cause the device 805 to perform various functions described herein. The code 835 may be stored in a non-transitory computer-readable medium such as system memory or another type of memory. In some cases, the code 835 may not be directly executable by the at least one processor 840 but may cause a computer (e.g., when compiled and executed) to perform functions described herein. In some cases, the at least one memory 830 may include, among other things, a basic I/O system (BIOS) which may control basic hardware or software operation such as the interaction with peripheral components or devices.

The at least one processor 840 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 840 may be configured to operate a memory array using a memory controller. In some other cases, a memory controller may be integrated into the at least one processor 840. The at least one processor 840 may be configured to execute computer-readable instructions stored in a memory (e.g., the at least one memory 830) to cause the device 805 to perform various functions (e.g., functions or tasks supporting link monitoring across multiple-cells for multi-carrier operation). For example, the device 805 or a component of the device 805 may include at least one processor 840 and at least one memory 830 coupled with or to the at least one processor 840, the at least one processor 840 and the at least one memory 830 configured to perform various functions described herein.

In some examples, the at least one processor 840 may include multiple processors and the at least one memory 830 may include multiple memories. One or more of the multiple processors may be coupled with one or more of the multiple memories, which may, individually or collectively, be configured to perform various functions described herein. In some examples, the at least one processor 840 may be a component of a processing system, which may refer to a system (such as a series) of machines, circuitry (including, for example, one or both of processor circuitry (which may include the at least one processor 840) and memory circuitry (which may include the at least one memory 830)), or components, that receives or obtains inputs and processes the inputs to produce, generate, or obtain a set of outputs. The processing system may be configured to perform one or more of the functions described herein. For example, the at least one processor 840 or a processing system including the at least one processor 840 may be configured to, configurable to, or operable to cause the device 805 to perform one or more of the functions described herein. Further, as described herein, being “configured to,” being “configurable to,” and being “operable to” may be used interchangeably and may be associated with a capability, when executing code 835 (e.g., processor-executable code) stored in the at least one memory 830 or otherwise, to perform one or more of the functions described herein.

The communications manager 820 may support wireless communications in accordance with examples as disclosed herein. For example, the communications manager 820 is capable of, configured to, or operable to support a means for receiving a control message indicating a multi-cell RLM configuration for a set of multiple cells including a primary cell and at least one secondary cell, the multi-cell RLM configuration indicating a set of multiple reference signal sets for monitoring the set of multiple cells. The communications manager 820 is capable of, configured to, or operable to support a means for monitoring the set of multiple reference signal sets to obtain a first channel quality metric associated with the primary cell and one or more second channel quality metrics associated with the at least one secondary cell in accordance with the multi-cell RLM configuration.

By including or configuring the communications manager 820 in accordance with examples as described herein, the device 805 may support techniques for reduced latency, more efficient utilization of communication resources, improved coordination between devices, and the like.

In some examples, the communications manager 820 may be configured to perform various operations (e.g., receiving, monitoring, transmitting) using or otherwise in cooperation with the transceiver 815, the one or more antennas 825, or any combination thereof. Although the communications manager 820 is illustrated as a separate component, in some examples, one or more functions described with reference to the communications manager 820 may be supported by or performed by the at least one processor 840, the at least one memory 830, the code 835, or any combination thereof. For example, the code 835 may include instructions executable by the at least one processor 840 to cause the device 805 to perform various aspects of link monitoring across multiple-cells for multi-carrier operation as described herein, or the at least one processor 840 and the at least one memory 830 may be otherwise configured to, individually or collectively, perform or support such operations.

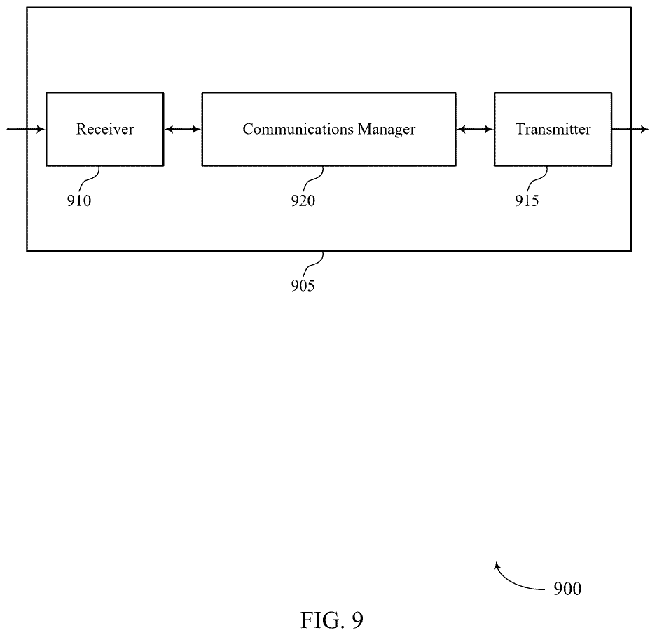

FIG. 9 shows a block diagram 900 of a device 905 that supports link monitoring across multiple-cells for multi-carrier operation in accordance with one or more aspects of the present disclosure. The device 905 may be an example of aspects of a network entity 105 (e.g., a primary cell) as described herein. The device 905 may include a receiver 910, a transmitter 915, and a communications manager 920. The device 905, or one or more components of the device 905 (e.g., the communications manager 920), may include at least one processor, which may be coupled with at least one memory, to, individually or collectively, support or enable the described techniques. Each of these components may be in communication with one another (e.g., via one or more buses).

The receiver 910 may provide a means for receiving information such as packets, user data, control information, or any combination thereof associated with various information channels (e.g., control channels, data channels, information channels related to link monitoring across multiple-cells for multi-carrier operation). Information may be passed on to other components of the device 905. The receiver 910 may utilize a single antenna or a set of multiple antennas.

The transmitter 915 may provide a means for transmitting signals generated by other components of the device 905. For example, the transmitter 915 may transmit information such as packets, user data, control information, or any combination thereof associated with various information channels (e.g., control channels, data channels, information channels related to link monitoring across multiple-cells for multi-carrier operation). In some examples, the transmitter 915 may be co-located with a receiver 910 in a transceiver module. The transmitter 915 may utilize a single antenna or a set of multiple antennas.

The communications manager 920, the receiver 910, the transmitter 915, or various combinations or components thereof may be examples of means for performing various aspects of link monitoring across multiple-cells for multi-carrier operation as described herein. For example, the communications manager 920, the receiver 910, the transmitter 915, or various combinations or components thereof may be capable of performing one or more of the functions described herein.

In some examples, the communications manager 920, the receiver 910, the transmitter 915, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 920, the receiver 910, the transmitter 915, or various combinations or components thereof may be implemented in code (e.g., as communications management software or firmware) executed by at least one processor (e.g., referred to as a processor-executable code). If implemented in code executed by at least one processor, the functions of the communications manager 920, the receiver 910, the transmitter 915, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 920 may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communications in accordance with examples as disclosed herein. For example, the communications manager 920 is capable of, configured to, or operable to support a means for transmitting a control message indicating a multi-cell radio link monitoring configuration for a set of multiple cells including a primary cell and at least one secondary cell, the multi-cell radio link monitoring configuration indicating a set of multiple reference signal sets for monitoring the set of multiple cells. The communications manager 920 is capable of, configured to, or operable to support a means for transmitting a first set of radio link monitoring reference signals via a first reference signal set of the set of multiple reference signal sets.

By including or configuring the communications manager 920 in accordance with examples as described herein, the device 905 (e.g., at least one processor controlling or otherwise coupled with the receiver 910, the transmitter 915, the communications manager 920, or a combination thereof) may support techniques for more efficient utilization of communication resources and the like.

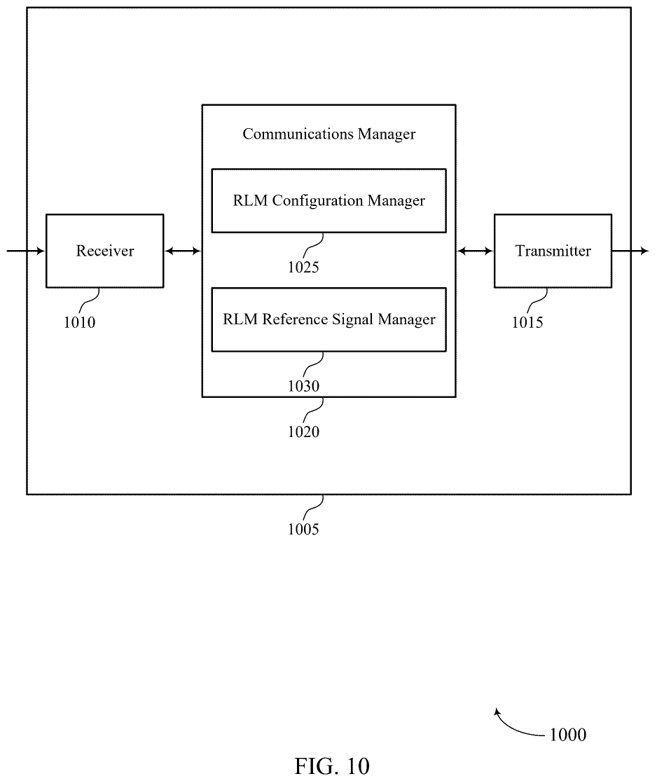

FIG. 10 shows a block diagram 1000 of a device 1005 that supports link monitoring across multiple-cells for multi-carrier operation in accordance with one or more aspects of the present disclosure. The device 1005 may be an example of aspects of a device 905 or a network entity 105 (e.g., a primary cell) as described herein. The device 1005 may include a receiver 1010, a transmitter 1015, and a communications manager 1020. The device 1005, or one or more components of the device 1005 (e.g., the communications manager 1020), may include at least one processor, which may be coupled with at least one memory, to support the described techniques. Each of these components may be in communication with one another (e.g., via one or more buses).

The receiver 1010 may provide a means for receiving information such as packets, user data, control information, or any combination thereof associated with various information channels (e.g., control channels, data channels, information channels related to link monitoring across multiple-cells for multi-carrier operation). Information may be passed on to other components of the device 1005. The receiver 1010 may utilize a single antenna or a set of multiple antennas.

The transmitter 1015 may provide a means for transmitting signals generated by other components of the device 1005. For example, the transmitter 1015 may transmit information such as packets, user data, control information, or any combination thereof associated with various information channels (e.g., control channels, data channels, information channels related to link monitoring across multiple-cells for multi-carrier operation). In some examples, the transmitter 1015 may be co-located with a receiver 1010 in a transceiver module. The transmitter 1015 may utilize a single antenna or a set of multiple antennas.

The device 1005, or various components thereof, may be an example of means for performing various aspects of link monitoring across multiple-cells for multi-carrier operation as described herein. For example, the communications manager 1020 may include an RLM configuration manager 1025, an RLM reference signal manager 1030, or any combination thereof. The communications manager 1020 may be an example of aspects of a communications manager 920 as described herein. In some examples, the communications manager 1020, or various components thereof, may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communications in accordance with examples as disclosed herein. The RLM configuration manager 1025 is capable of, configured to, or operable to support a means for transmitting a control message indicating a multi-cell radio link monitoring configuration for a set of multiple cells including a primary cell and at least one secondary cell, the multi-cell radio link monitoring configuration indicating a set of multiple reference signal sets for monitoring the set of multiple cells. The RLM reference signal manager 1030 is capable of, configured to, or operable to support a means for transmitting a first set of radio link monitoring reference signals via a first reference signal set of the set of multiple reference signal sets.

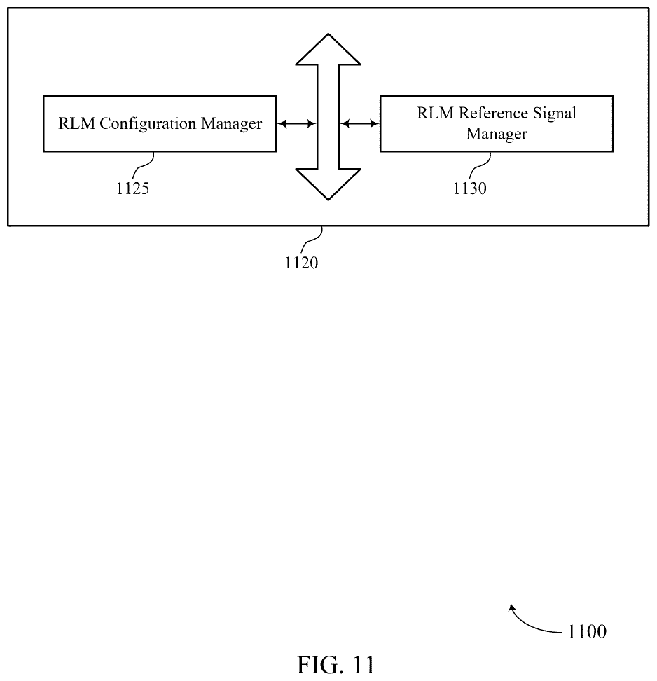

FIG. 11 shows a block diagram 1100 of a communications manager 1120 that supports link monitoring across multiple-cells for multi-carrier operation in accordance with one or more aspects of the present disclosure. The communications manager 920 may be an example of aspects of a communications manager 1120, a communications manager 1020, or both, as described herein. The communications manager 1120, or various components thereof, may be an example of means for performing (e.g., to cause the communications manager 1120 to perform) various aspects of flexible link monitoring for multi-carrier operation as described herein. For example, the communications manager 1120 may include an RLM configuration manager 1125, an RLM reference signal manager 1130, or any combination thereof. Each of these components, or components or subcomponents thereof (e.g., one or more processors, one or more memories), may communicate, directly or indirectly, with one another (e.g., via one or more buses). The communications may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1120 may support wireless communications in accordance with examples as disclosed herein. The RLM configuration manager 1125 is capable of, configured to, or operable to support a means for transmitting a control message indicating a multi-cell radio link monitoring configuration for a set of multiple cells including a primary cell and at least one secondary cell, the multi-cell radio link monitoring configuration indicating a set of multiple reference signal sets for monitoring the set of multiple cells. The RLM reference signal manager 1130 is capable of, configured to, or operable to support a means for transmitting a first set of radio link monitoring reference signals via a first reference signal set of the set of multiple reference signal sets.

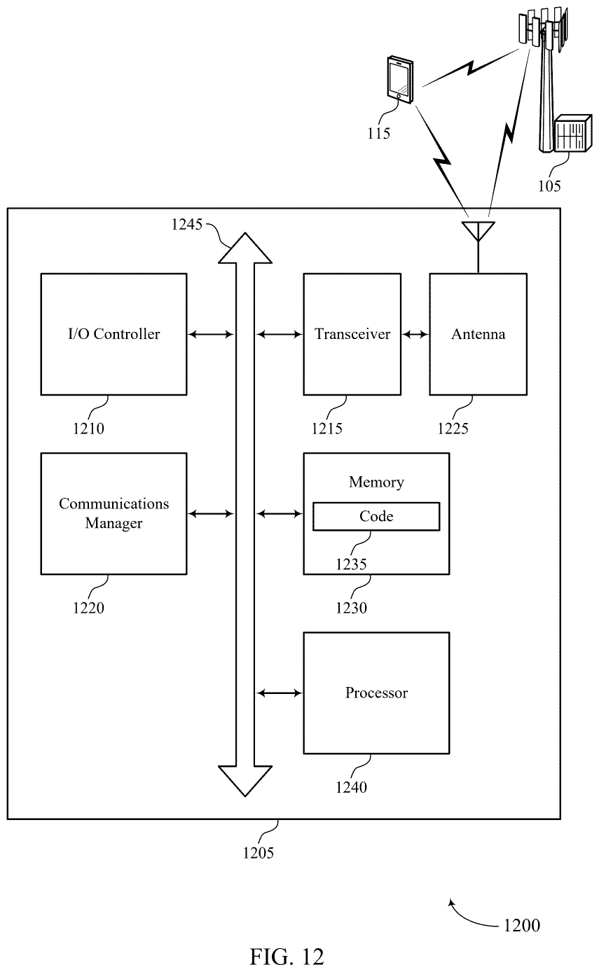

FIG. 12 shows a diagram of a system 1200 including a device 1205 that supports link monitoring across multiple-cells for multi-carrier operation in accordance with one or more aspects of the present disclosure. The device 1205 may be an example of or include components of a device 905, a device 1005, or a network entity 105 (e.g., a primary cell) as described herein. The device 1205 may communicate (e.g., wirelessly) with one or more other devices (e.g., network entities 105, UEs 115, or a combination thereof). The device 1205 may include components for bi-directional voice and data communications including components for transmitting and receiving communications, such as a communications manager 1220, an I/O controller 1210, a transceiver 1215, one or more antennas 1225, at least one memory 1230, code 1235, and at least one processor 1240. These components may be in electronic communication or otherwise coupled (e.g., operatively, communicatively, functionally, electronically, electrically) via one or more buses (e.g., a bus 1245).

The I/O controller 1210 may manage input and output signals for the device 1205. The I/O controller 1210 may also manage peripherals not integrated into the device 1205. In some cases, the I/O controller 1210 may represent a physical connection or port to an external peripheral. In some cases, the I/O controller 1210 may utilize an operating system such as iOS®, ANDROID®, MS-DOS®, MS-WINDOWS®, OS/2®, UNIX®, LINUX®, or another known operating system. Additionally, or alternatively, the I/O controller 1210 may represent or interact with a modem, a keyboard, a mouse, a touchscreen, or a similar device. In some cases, the I/O controller 1210 may be implemented as part of one or more processors, such as the at least one processor 1240. In some cases, a user may interact with the device 1205 via the I/O controller 1210 or via hardware components controlled by the I/O controller 1210.

In some cases, the device 1205 may include a single antenna. However, in some other cases, the device 1205 may have more than one antenna, which may be capable of concurrently transmitting or receiving multiple wireless transmissions. The transceiver 1215 may communicate bi-directionally via the one or more antennas 1225 using wired or wireless links as described herein. For example, the transceiver 1215 may represent a wireless transceiver and may communicate bi-directionally with another wireless transceiver. The transceiver 1215 may also include a modem to modulate the packets, to provide the modulated packets to one or more antennas 1225 for transmission, and to demodulate packets received from the one or more antennas 1225. The transceiver 1215, or the transceiver 1215 and one or more antennas 1225, may be an example of a transmitter 915, a transmitter 1015, a receiver 910, a receiver 1010, or any combination thereof or component thereof, as described herein.

The at least one memory 1230 may include RAM and ROM. The at least one memory 1230 may store computer-readable, computer-executable, or processor-executable code, such as the code 1235. The code 1235 may include instructions that, when executed by the at least one processor 1240, cause the device 1205 to perform various functions described herein. The code 1235 may be stored in a non-transitory computer-readable medium such as system memory or another type of memory. In some cases, the code 1235 may not be directly executable by the at least one processor 1240 but may cause a computer (e.g., when compiled and executed) to perform functions described herein. In some cases, the at least one memory 1230 may include, among other things, a BIOS which may control basic hardware or software operation such as the interaction with peripheral components or devices.

The at least one processor 1240 may include one or more intelligent hardware devices (e.g., one or more general-purpose processors, one or more DSPs, one or more CPUs, one or more GPUs, one or more NPUs (also referred to as neural network processors or DLPs), one or more microcontrollers, one or more ASICs, one or more FPGAs, one or more programmable logic devices, discrete gate or transistor logic, one or more discrete hardware components, or any combination thereof). In some cases, the at least one processor 1240 may be configured to operate a memory array using a memory controller. In some other cases, a memory controller may be integrated into the at least one processor 1240. The at least one processor 1240 may be configured to execute computer-readable instructions stored in a memory (e.g., the at least one memory 1230) to cause the device 1205 to perform various functions (e.g., functions or tasks supporting link monitoring across multiple-cells for multi-carrier operation). For example, the device 1205 or a component of the device 1205 may include at least one processor 1240 and at least one memory 1230 coupled with or to the at least one processor 1240, the at least one processor 1240 and the at least one memory 1230 configured to perform various functions described herein.

In some examples, the at least one processor 1240 may include multiple processors and the at least one memory 1230 may include multiple memories. One or more of the multiple processors may be coupled with one or more of the multiple memories, which may, individually or collectively, be configured to perform various functions described herein. In some examples, the at least one processor 1240 may be a component of a processing system, which may refer to a system (such as a series) of machines, circuitry (including, for example, one or both of processor circuitry (which may include the at least one processor 1240) and memory circuitry (which may include the at least one memory 1230)), or components, that receives or obtains inputs and processes the inputs to produce, generate, or obtain a set of outputs. The processing system may be configured to perform one or more of the functions described herein. For example, the at least one processor 1240 or a processing system including the at least one processor 1240 may be configured to, configurable to, or operable to cause the device 1205 to perform one or more of the functions described herein. Further, as described herein, being “configured to,” being “configurable to,” and being “operable to” may be used interchangeably and may be associated with a capability, when executing code 1235 (e.g., processor-executable code) stored in the at least one memory 1230 or otherwise, to perform one or more of the functions described herein.

The communications manager 1220 may support wireless communications in accordance with examples as disclosed herein. For example, the communications manager 1220 is capable of, configured to, or operable to support a means for transmitting a control message indicating a multi-cell radio link monitoring configuration for a set of multiple cells including a primary cell and at least one secondary cell, the multi-cell radio link monitoring configuration indicating a set of multiple reference signal sets for monitoring the set of multiple cells. The communications manager 1220 is capable of, configured to, or operable to support a means for transmitting a first set of radio link monitoring reference signals via a first reference signal set of the set of multiple reference signal sets.

By including or configuring the communications manager 1220 in accordance with examples as described herein, the device 1205 may support techniques for reduced latency, more efficient utilization of communication resources, improved coordination between devices, and the like.

In some examples, the communications manager 1220 may be configured to perform various operations (e.g., receiving, monitoring, transmitting) using or otherwise in cooperation with the transceiver 1215, the one or more antennas 1225, or any combination thereof. Although the communications manager 1220 is illustrated as a separate component, in some examples, one or more functions described with reference to the communications manager 1220 may be supported by or performed by the at least one processor 1240, the at least one memory 1230, the code 1235, or any combination thereof. For example, the code 1235 may include instructions executable by the at least one processor 1240 to cause the device 1205 to perform various aspects of link monitoring across multiple-cells for multi-carrier operation as described herein, or the at least one processor 1240 and the at least one memory 1230 may be otherwise configured to, individually or collectively, perform or support such operations.

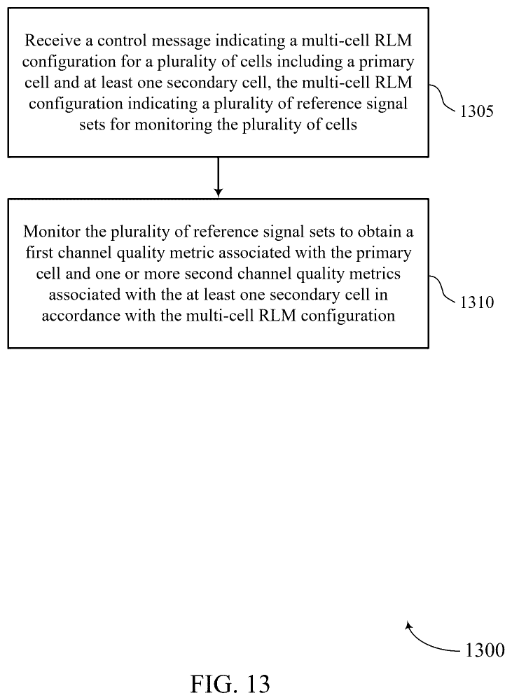

FIG. 13 shows a flowchart illustrating a method 1300 that supports link monitoring across multiple-cells for multi-carrier operation in accordance with one or more aspects of the present disclosure. The operations of the method 1300 may be implemented by a UE or its components as described herein. For example, the operations of the method 1300 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1305, the method may include receiving a control message indicating a multi-cell RLM configuration for a plurality of cells including a primary cell and at least one secondary cell, the multi-cell RLM configuration indicating a plurality of reference signal sets for monitoring the plurality of cells. The operations of 1305 may be performed in accordance with examples as disclosed herein. In some examples, aspects of the operations of 1305 may be performed by an RLM configuration component 725 as described with reference to FIG. 7.

At 1310, the method may include monitoring the plurality of reference signal sets to obtain a first channel quality metric associated with the primary cell and one or more second channel quality metrics associated with the at least one secondary cell in accordance with the multi-cell RLM configuration. The operations of 1310 may be performed in accordance with examples as disclosed herein. In some examples, aspects of the operations of 1310 may be performed by a channel quality metric component 730 as described with reference to FIG. 7.

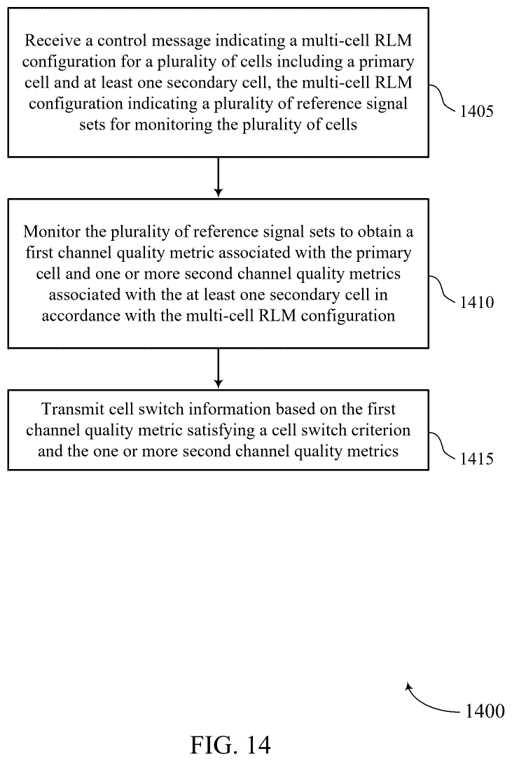

FIG. 14 shows a flowchart illustrating a method 1400 that supports link monitoring across multiple-cells for multi-carrier operation in accordance with one or more aspects of the present disclosure. The operations of the method 1400 may be implemented by a UE or its components as described herein. For example, the operations of the method 1400 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1405, the method may include receiving a control message indicating a multi-cell RLM configuration for a plurality of cells including a primary cell and at least one secondary cell, the multi-cell RLM configuration indicating a plurality of reference signal sets for monitoring the plurality of cells. The operations of 1405 may be performed in accordance with examples as disclosed herein. In some examples, aspects of the operations of 1405 may be performed by an RLM configuration component 725 as described with reference to FIG. 7.

At 1410, the method may include monitoring the plurality of reference signal sets to obtain a first channel quality metric associated with the primary cell and one or more second channel quality metrics associated with the at least one secondary cell in accordance with the multi-cell RLM configuration. The operations of 1410 may be performed in accordance with examples as disclosed herein. In some examples, aspects of the operations of 1410 may be performed by a channel quality metric component 730 as described with reference to FIG. 7.

At 1415, the method may include transmitting cell switch information based on the first channel quality metric satisfying a cell switch criterion and the one or more second channel quality metrics. The operations of 1415 may be performed in accordance with examples as disclosed herein. In some examples, aspects of the operations of 1415 may be performed by a cell switch component 735 as described with reference to FIG. 7.

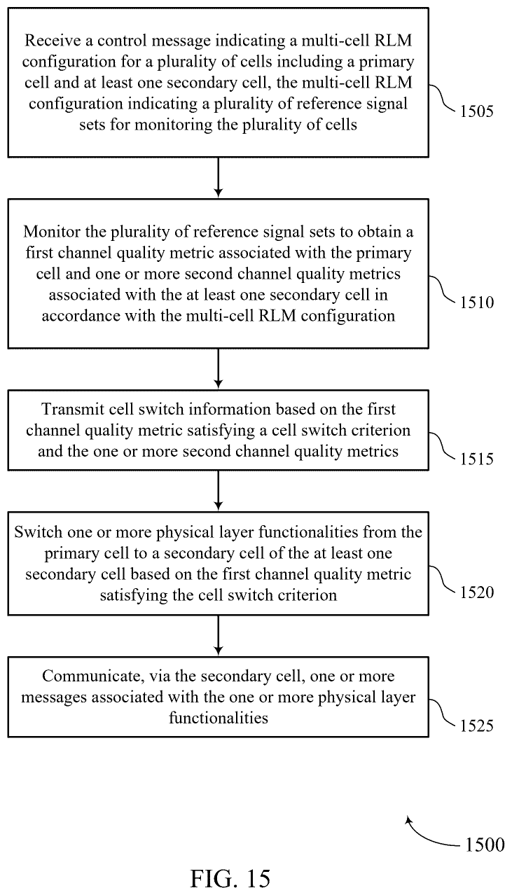

FIG. 15 shows a flowchart illustrating a method 1500 that supports link monitoring across multiple-cells for multi-carrier operation in accordance with one or more aspects of the present disclosure. The operations of the method 1500 may be implemented by a UE or its components as described herein. For example, the operations of the method 1500 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1505, the method may include receiving a control message indicating a multi-cell RLM configuration for a plurality of cells including a primary cell and at least one secondary cell, the multi-cell RLM configuration indicating a plurality of reference signal sets for monitoring the plurality of cells. The operations of 1505 may be performed in accordance with examples as disclosed herein. In some examples, aspects of the operations of 1505 may be performed by an RLM configuration component 725 as described with reference to FIG. 7.

At 1510, the method may include monitoring the plurality of reference signal sets to obtain a first channel quality metric associated with the primary cell and one or more second channel quality metrics associated with the at least one secondary cell in accordance with the multi-cell RLM configuration. The operations of 1510 may be performed in accordance with examples as disclosed herein. In some examples, aspects of the operations of 1510 may be performed by a channel quality metric component 730 as described with reference to FIG. 7.

At 1515, the method may include transmitting cell switch information based on the first channel quality metric satisfying a cell switch criterion and the one or more second channel quality metrics. The operations of 1515 may be performed in accordance with examples as disclosed herein. In some examples, aspects of the operations of 1515 may be performed by a cell switch component 735 as described with reference to FIG. 7.

At 1520, the method may include switching one or more physical layer functionalities from the primary cell to a secondary cell of the at least one secondary cell based on the first channel quality metric satisfying the cell switch criterion. The operations of 1520 may be performed in accordance with examples as disclosed herein. In some examples, aspects of the operations of 1520 may be performed by a cell switch component 735 as described with reference to FIG. 7.

At 1525, the method may include communicating, via the secondary cell, one or more messages associated with the one or more physical layer functionalities. The operations of 1525 may be performed in accordance with examples as disclosed herein. In some examples, aspects of the operations of 1525 may be performed by a cell switch component 735 as described with reference to FIG. 7.

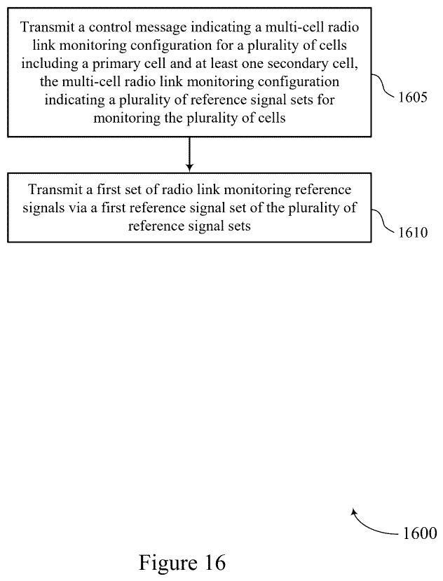

FIG. 16 shows a flowchart illustrating a method 1600 that supports link monitoring across multiple-cells for multi-carrier operation in accordance with one or more aspects of the present disclosure. The operations of the method 1600 may be implemented by a network entity or its components as described herein. For example, the operations of the method 1600 may be performed by a network entity (e.g., a primary cell) as described with reference to FIGS. 1 through 4 and 9 through 12. In some examples, a network entity may execute a set of instructions to control the functional elements of the network entity to perform the described functions. Additionally, or alternatively, the network entity may perform aspects of the described functions using special-purpose hardware.

At 1605, the method may include transmitting a control message indicating a multi-cell radio link monitoring configuration for a plurality of cells including the primary cell and at least one secondary cell, the multi-cell radio link monitoring configuration indicating a plurality of reference signal sets for monitoring the plurality of cells. In some examples, aspects of the operations of 1605 may be performed by an RLM configuration manager 1125.

At 1610, the method may include transmitting a first set of radio link monitoring reference signals via a first reference signal set of the plurality of reference signal sets. In some examples, aspects of the operations of 1610 may be performed by an RLM reference signal manager 1130.

The following provides an overview of aspects of the present disclosure:

Aspect 1: A method by a UE, comprising: receiving a control message indicating a multi-cell RLM configuration for a plurality of cells comprising a primary cell and at least one secondary cell, the multi-cell RLM configuration indicating a plurality of reference signal sets for monitoring the plurality of cells; and monitoring the plurality of reference signal sets to obtain a first channel quality metric associated with the primary cell and one or more second channel quality metrics associated with the at least one secondary cell in accordance with the multi-cell RLM configuration.

Aspect 2: The method of aspect 1, further comprising: transmitting cell switch information based at least in part on the first channel quality metric satisfying a cell switch criterion and the one or more second channel quality metrics.

Aspect 3: The method of aspect 2, wherein monitoring the plurality of reference signal sets further comprises: monitoring a first reference signal set of the plurality of reference signal sets to obtain the first channel quality metric associated with the primary cell; and monitoring, based at least in part on the first channel quality metric satisfying the cell switch criterion, a second reference signal set of the plurality of reference signal sets to obtain the one or more second channel quality metrics.

Aspect 4: The method of aspect 3, further comprising: receiving an indication of a secondary cell of the at least one secondary cell, wherein the second reference signal set is monitored based at least in part on the indication of the secondary cell.

Aspect 5: The method of any of aspects 2 through 4, further comprising: detecting a quantity of OoS indications that occur prior to a monitoring window; and detecting a quantity of IS indications that occur during the monitoring window, wherein the first channel quality metric satisfies the cell switch criterion based at least in part on the quantity of OoS indications satisfying a first threshold and the quantity of IS indications satisfying a second threshold.

Aspect 6: The method of any of aspects 2 through 5, further comprising: switching one or more physical layer functionalities from the primary cell to a secondary cell of the at least one secondary cell based at least in part on the first channel quality metric satisfying the cell switch criterion; and communicating, via the secondary cell, one or more messages associated with the one or more physical layer functionalities.

Aspect 7: The method of aspect 6, further comprising: refraining, after switching the one or more physical layer functionalities from the primary cell to the secondary cell, from monitoring a first reference signal set of the plurality of reference signal sets based at least in part on the first channel quality metric satisfying the cell switch criterion, wherein the first reference signal set is associated with the primary cell.

Aspect 8: The method of aspect 6, further comprising: monitoring, after switching the one or more physical layer functionalities from the primary cell to the secondary cell, a first reference signal set of the plurality of reference signal sets, wherein the first reference signal set is associated with the primary cell.

Aspect 9: The method of any of aspects 2 through 8, further comprising: transmitting an indication of RLF based at least in part on the first channel quality metric satisfying the cell switch criterion and the one or more second channel quality metrics satisfying a RLF threshold.

Aspect 10: The method of any of aspects 2 through 9, wherein transmitting the cell switch information further comprises: transmitting, via uplink resources indicated by the multi-cell RLM configuration, an indication that one or more physical layer functionalities have been switched from the primary cell to a secondary cell of the at least one secondary cell.

Aspect 11: The method of aspect 10, wherein the uplink resources are associated with the secondary cell.

Aspect 12: The method of any of aspects 10 through 11, wherein transmitting the cell switch information further comprises: transmitting an indication of a beam associated with the secondary cell based at least in part on a beam quality metric associated with the beam.

Aspect 13: The method of any of aspects 2 through 12, further comprising: receiving, based at least in part on the cell switch information, a second control message indicating a communication configuration for a secondary cell of the at least one secondary cell; and communicating, via the secondary cell, one or more messages in accordance with the communication configuration.

Aspect 14: The method of any of aspects 2 through 9 and 13, wherein transmitting the cell switch information further comprises: transmitting an indication of one or more secondary cells of the at least one secondary cell, wherein each second channel quality metric of the one or more second channel quality metrics associated with the one or more secondary cells satisfies a threshold.

Aspect 15: The method of aspect 14, further comprising: receiving an indication of a secondary cell of the one or more secondary cells based at least in part on the indication of the one or more secondary cells; and communicating, via the secondary cell, one or more messages based at least in part on the indication of the secondary cell.

Aspect 16: A UE comprising one or more memories storing processor-executable code, and one or more processors coupled with the one or more memories and individually or collectively operable to execute the code to cause the UE to perform a method of any of aspects 1 through 15.

Aspect 17: A UE comprising at least one means for performing a method of any of aspects 1 through 15.

Aspect 18: A non-transitory computer-readable medium storing code the code comprising instructions executable by one or more processors to perform a method of any of aspects 1 through 15.

Aspect 19: A method for wireless communications by a network entity, comprising: transmitting a control message indicating a multi-cell radio link monitoring configuration for a plurality of cells comprising a primary cell and at least one secondary cell, the multi-cell radio link monitoring configuration indicating a plurality of reference signal sets for monitoring the plurality of cells transmitting a first set of radio link monitoring reference signals via a first reference signal set of the plurality of reference signal sets.

Aspect 20: A network entity comprising one or more memories storing processor-executable code, and one or more processors coupled with the one or more memories and individually or collectively operable to execute the code to cause the primary cell to perform a method of aspect 19.

Aspect 21: A network entity comprising at least one means for performing a method of aspect 19.

Aspect 22: A non-transitory computer-readable medium storing code the code comprising instructions executable by one or more processors to perform a method of aspect 19.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

Also, as used herein, the phrase “a set” shall be construed as including the possibility of a set with one member. That is, the phrase “a set” shall be construed in the same manner as “one or more.”

What is claimed is:

1. A user equipment (UE), comprising:
one or more memories storing processor-executable code; and
one or more processors coupled with the one or more memories and individually or collectively operable to execute the code to cause the UE to:
receive a control message indicating a multi-cell radio link monitoring configuration for a plurality of cells comprising a primary cell and at least one secondary cell, the multi-cell radio link monitoring configuration indicating a plurality of reference signal sets for monitoring the plurality of cells; and
monitor the plurality of reference signal sets to obtain a first channel quality metric associated with the primary cell and one or more second channel quality metrics associated with the at least one secondary cell in accordance with the multi-cell radio link monitoring configuration.

2. The UE of claim 1, wherein the one or more processors are individually or collectively further operable to execute the code to cause the UE to:
transmit cell switch information based at least in part on the first channel quality metric satisfying a cell switch criterion and the one or more second channel quality metrics.

3. The UE of claim 2, wherein, to monitor the plurality of reference signal sets, the one or more processors are individually or collectively further operable to execute the code to cause the UE to:
monitor a first reference signal set of the plurality of reference signal sets to obtain the first channel quality metric associated with the primary cell; and
monitor, based at least in part on the first channel quality metric satisfying the cell switch criterion, a second reference signal set of the plurality of reference signal sets to obtain the one or more second channel quality metrics.

4. The UE of claim 3, wherein the one or more processors are individually or collectively further operable to execute the code to cause the UE to:
receive an indication of a secondary cell of the at least one secondary cell, wherein the second reference signal set is monitored based at least in part on the indication of the secondary cell.

5. The UE of claim 2, wherein the one or more processors are individually or collectively further operable to execute the code to cause the UE to:
detect a quantity of out-of-sync indications that occur prior to a monitoring window; and
detect a quantity of in-sync indications that occur during the monitoring window, wherein the first channel quality metric satisfies the cell switch criterion based at least in part on the quantity of out-of-sync indications satisfying a first threshold and the quantity of in-sync indications satisfying a second threshold.

6. The UE of claim 2, wherein the one or more processors are individually or collectively further operable to execute the code to cause the UE to:
switch one or more physical layer functionalities from the primary cell to a secondary cell of the at least one secondary cell based at least in part on the first channel quality metric satisfying the cell switch criterion; and
communicate, via the secondary cell, one or more messages associated with the one or more physical layer functionalities.

7. The UE of claim 6, wherein the one or more processors are individually or collectively further operable to execute the code to cause the UE to:
refrain, after switching the one or more physical layer functionalities from the primary cell to the secondary cell, from monitoring a first reference signal set of the plurality of reference signal sets based at least in part on the first channel quality metric satisfying the cell switch criterion, wherein the first reference signal set is associated with the primary cell.

8. The UE of claim 6, wherein the one or more processors are individually or collectively further operable to execute the code to cause the UE to:
monitor, after switching the one or more physical layer functionalities from the primary cell to the secondary cell, a first reference signal set of the plurality of reference signal sets, wherein the first reference signal set is associated with the primary cell.

9. The UE of claim 2, wherein the one or more processors are individually or collectively further operable to execute the code to cause the UE to:
transmit an indication of radio link failure based at least in part on the first channel quality metric satisfying the cell switch criterion and the one or more second channel quality metrics satisfying a radio link failure threshold.

10. The UE of claim 2, wherein, to transmit the cell switch information, the one or more processors are individually or collectively further operable to execute the code to cause the UE to:
transmit, via uplink resources indicated by the multi-cell radio link monitoring configuration, an indication that one or more physical layer functionalities have been switched from the primary cell to a secondary cell of the at least one secondary cell.

11. The UE of claim 10, wherein the uplink resources are associated with the secondary cell.

12. The UE of claim 10, wherein, to transmit the cell switch information, the one or more processors are individually or collectively further operable to execute the code to cause the UE to:
transmit an indication of a beam associated with the secondary cell based at least in part on a beam quality metric associated with the beam.

13. The UE of claim 2, wherein the one or more processors are individually or collectively further operable to execute the code to cause the UE to:
receive, based at least in part on the cell switch information, a second control message indicating a communication configuration for a secondary cell of the at least one secondary cell; and
communicate, via the secondary cell, one or more messages in accordance with the communication configuration.

14. The UE of claim 2, wherein, to transmit the cell switch information, the one or more processors are individually or collectively further operable to execute the code to cause the UE to:
transmit an indication of one or more secondary cells of the at least one secondary cell, wherein each second channel quality metric of the one or more second channel quality metrics associated with the one or more secondary cells satisfies a threshold.

15. The UE of claim 14, wherein the one or more processors are individually or collectively further operable to execute the code to cause the UE to:
receive an indication of a secondary cell of the one or more secondary cells based at least in part on the indication of the one or more secondary cells; and
communicate, via the secondary cell, one or more messages based at least in part on the indication of the secondary cell.

16. A method for wireless communications at a user equipment (UE), comprising:
receiving a control message indicating a multi-cell radio link monitoring configuration for a plurality of cells comprising a primary cell and at least one secondary cell, the multi-cell radio link monitoring configuration indicating a plurality of reference signal sets for monitoring the plurality of cells; and
monitoring the plurality of reference signal sets to obtain a first channel quality metric associated with the primary cell and one or more second channel quality metrics associated with the at least one secondary cell in accordance with the multi-cell radio link monitoring configuration.

17. The method of claim 16, further comprising:
transmitting cell switch information based at least in part on the first channel quality metric satisfying a cell switch criterion and the one or more second channel quality metrics.

18. The method of claim 17, wherein monitoring the plurality of reference signal sets comprising:
monitoring a first reference signal set of the plurality of reference signal sets to obtain the first channel quality metric associated with the primary cell; and
monitoring, based at least in part on the first channel quality metric satisfying the cell switch criterion, a second reference signal set of the plurality of reference signal sets to obtain the one or more second channel quality metrics.

19. The method of claim 18, further comprising:
receiving an indication of a secondary cell of the at least one secondary cell, wherein the second reference signal set is monitored based at least in part on the indication of the secondary cell.

20. A network entity for wireless communication, comprising:
one or more memories storing processor-executable code; and
one or more processors coupled with the one or more memories and individually or collectively operable to execute the code to cause the network entity to:
transmit a control message indicating a multi-cell radio link monitoring configuration for a plurality of cells comprising a primary cell and at least one secondary cell, the multi-cell radio link monitoring configuration indicating a plurality of reference signal sets for monitoring the plurality of cells; and
transmit a first set of radio link monitoring reference signals via a first reference signal set of the plurality of reference signal sets.
